(19) United States
(12) Patent Application Publication
(10) Pub. No.: US 2024/0225255 A9
(43) Pub. Date: Jul. 11, 2024

(54) BRUSH HEAD AND ELECTRIC TOOTHBRUSH

(71) Applicant: GUANGZHOU STARS PULSE CO., LTD., GUANGZHOU (CN)

(72) Inventors: HUIJIA LIANG, GUANGZHOU (CN); YUWEI ZHANG, GUANGZHOU (CN)

(21) Appl. No.: 18/402,836

(22) Filed: Jan. 3, 2024

Related U.S. Application Data
(63) Continuation of application No. PCT/CN2023/120651, filed on Sep. 22, 2023.

(30) Foreign Application Priority Data
Sep. 23, 2022 (CN) 202222549440.5
Sep. 23, 2022 (CN) 202222549474.4
Sep. 23, 2022 (CN) 202222549713.6
Jun. 16, 2023 (CN) 202321557559.5
Jul. 31, 2023 (CN) 202322046784.9

(51) Int. Cl. A46B 9/04; A46B 5/00

(52) U.S. Cl. CPC A46B 9/04; A46B 5/0095; A46B 2200/1066

(57) ABSTRACT

A brush head and an electric toothbrush are provided. The brush head includes a brush rod, a brush plate, and a soft elastic piece. The brush plate includes a bristle fixing plate and a back plate. The back plate and/or the bristle fixing plate is connected to the brush rod. Bristles are extended from the bristle fixing plate. The back plate is disposed on one side of the bristle fixing plate away from the bristles. A portion of the back plate is spaced apart from the back surface of the bristle fixing plate to define a filling groove. The back plate is connected to the bristle fixing plate through a first connecting end and/or a second connecting end thereof. The soft elastic piece is filled in the filling groove. The soft elastic piece is covered on the back plate and at least a part of the peripheral side surface.

### TECHNICAL FIELD

The present disclosure relates to a technical field of oral cleaning, and in particular to a brush head and an electric toothbrush having the same.

### BACKGROUND

In the prior art, an electric toothbrush drives a brush head thereof to vibrate at high frequency, and the brush head vibrating at high frequency contacts teeth or gums to clean a user's oral cavity. However, since a brush plate of the brush head is made of hard material, such as plastic, during a high-frequency vibration of the brush head, the brush plate hits the teeth or the gums, which may cause discomfort to the user or cause damage to the oral cavity.

### SUMMARY

The present disclosure provides a brush head and an electric toothbrush, which not only have good cushioning performance, but also effectively protect teeth and gums. In addition, a soft elastic piece thereof is firmly connected to a brush plate thereof.

In a first aspect, embodiments of the present disclosure provide the brush head. The brush head comprises a brush rod, a brush plate, bristles, and a soft elastic piece. The brush rod defines a length direction. The brush plate comprises a bristle fixing plate and a back plate. At least one of the back plate and the bristle fixing plate is connected to the brush rod. The bristle fixing plate comprises a bristle fixing surface, a back surface, and a peripheral side surface. The back surface of the bristle fixing plate is opposite to the bristle fixing surface of the bristle fixing plate. The peripheral side surface of the bristle fixing plate is located between the bristle fixing surface and the back surface of the bristle fixing plate. The bristles are extended from the bristle fixing surface of the bristle fixing plate. The back plate is disposed on one side of the bristle fixing plate away from the bristles. A portion of the back plate is spaced apart from the back surface of the bristle fixing plate to define a filling groove. The back plate comprises a first connecting end close to the brush rod and a second connecting end away from the brush rod along the length direction. The back plate is connected to the bristle fixing plate through the first connecting end and/or the second connecting end of the back plate.

It should be noted that positions of the first connecting end and the second connecting of the back plate with respect to the bristle fixing plate are not limited. For instance, the first connecting end of the back plate may be corresponding to an upper portion, a middle portion, or a lower portion of the bristle fixing plate. Only is the second connecting end of the bristle fixing plate is farther away from the brush rod than the first connecting end of the back plate.

The soft elastic piece is filled in the filling groove. The soft elastic piece is covered on the back plate and at least a part of the peripheral side surface of the bristle fixing plate.

In a second aspect, the present disclosure provides the electric toothbrush. The electric toothbrush comprises a brush head and a brush handle assembly. The brush head comprises a brush rod, a brush plate, bristles, and a soft elastic piece. The brush rod defines a length direction. The brush plate comprises a bristle fixing plate and a back plate. At least one of the back plate and the bristle fixing plate is connected to the brush rod. The bristle fixing plate comprises a bristle fixing surface, a back surface, and a peripheral side surface. The back surface of the bristle fixing plate is opposite to the bristle fixing surface of the bristle fixing plate. The peripheral side surface of the bristle fixing plate is located between the bristle fixing surface and the back surface of the bristle fixing plate. The bristles are extended from the bristle fixing surface of the bristle fixing plate. The back plate is disposed on one side of the bristle fixing plate away from the bristles. A portion of the back plate is spaced apart from the back surface of the bristle fixing plate to define a filling groove. The back plate comprises a first connecting end close to the brush rod and a second connecting end away from the brush rod along the length direction. The back plate is connected to the bristle fixing plate through the first connecting end and/or the second connecting end of the back plate. The soft elastic piece is filled in the filling groove. The soft elastic piece is covered on the back plate and at least a part of the peripheral side surface of the bristle fixing plate. The brush handle assembly is detachably connected to the brush head.

According to the brush head and the electric toothbrush disclosed by the embodiments of the present disclosure, the portion of the back plate is spaced apart from the back surface of the bristle fixing plate to define the filling groove. The soft elastic piece is disposed to cover the back plate and fill the filling groove. The soft elastic piece further covers the back surface of the bristle fixing plate, and the soft elastic piece at least covers a circle area of the peripheral side surface, close to the back surface, of the bristle fixing plate. Therefore, the brush head of the present disclosure has two characteristics.

First, in terms of a cushioning effect, since the soft elastic piece covers the back plate and the back surface of the bristle fixing plate, a back portion of the brush head contacts the oral cavity of the user through the soft elastic piece, and the soft elastic piece at least covers the circle area of the peripheral side surface, close to the back surface, of the bristle fixing plate, so that the peripheral side surface of the brush head contacts the oral cavity of the user through the soft elastic piece, and a front side of the brush head contacts the oral cavity of the user through the bristles. In summary, except that the bristles are in contact with the oral cavity of the user, the bristle fixing plate is hardly in contact with the oral cavity of the user, and the back plate is not in contact with the oral cavity of the user. That is, the brush head is in contact with the oral cavity of the user through the soft elastic piece except for the front side thereof where the bristles are disposed. Since the soft elastic piece is made of soft material and prone to elastic deformation, the soft elastic piece has a good cushioning effect and the oral cavity of the user is effectively protected.

Second, in terms of connection stability of the soft elastic piece and the brush plate, since the soft elastic piece is filled in the filling groove, and the filling groove is formed by spacing apart the back plate from the bristle fixing plate along the thickness direction of the brush plate, the filling groove and the soft elastic piece are mutually limited, so that the soft elastic piece is unable to be loosened along the thickness direction of the brush plate, and the soft elastic piece do not peel off from the brush plate. Moreover, since the soft elastic piece at least covers the circle area of the peripheral side surface, close to the back surface, of the bristle fixing plate, the peripheral side surface of the bristle fixing plate and the soft elastic piece are also mutually limited, so that the soft elastic piece is not loosened along any direction in a plane where the brush plate is located, nor the soft elastic piece peeling off from the brush plate. In addition, the soft elastic piece is formed by injection molding on the brush plate to fill the filling groove, and cover the back plate, the back surface, and the circle area of the peripheral side surface of the bristle fixing plate, so that there is a strong bonding force between the soft elastic piece, the back plate, and the bristle fixing plate. Therefore, there is a good connection stability between the soft elastic piece and the brush plate.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a structural schematic diagram of an electric toothbrush according to one embodiment of the present disclosure.

FIG. 2 is a structural schematic diagram of a brush head according to one embodiment of the present disclosure.

FIG. 3 is an exploded schematic diagram of the brush head shown in FIG. 2.

FIG. 4 is another structural schematic diagram of the brush head shown in FIG. 2.

FIG. 5 is a cross-sectional schematic diagram of the brush head taken along the line-D-D shown in FIG. 4.

FIG. 6 is an enlarged schematic diagram of portion A shown in FIG. 5.

FIG. 7 is an exploded schematic diagram of a part of the brush head shown in FIG. 2.

FIG. 8 is a structural schematic diagram of a soft elastic piece of the brush head shown in FIG. 2.

FIG. 9 is another structural schematic diagram of the soft elastic piece of the brush head shown in FIG. 2.

FIG. 10 is a cross-sectional schematic diagram of the soft elastic piece of the brush head taken along the line-F-F shown in FIG. 9.

FIG. 11 is a structural schematic diagram of an alternative embodiment of a brush plate of the brush head of the present disclosure.

FIG. 12 is a structural schematic diagram of another alternative embodiment of the brush plate of the brush head shown in FIG. 2.

FIG. 13 is a structural schematic diagram of another alternative embodiment of the brush plate of the brush head shown in FIG. 2

FIG. 14 is a structural schematic diagram of the brush head according to another embodiment of the present disclosure.

FIG. 15 is an exploded structural schematic diagram of the brush head shown in FIG. 14.

FIG. 16 is a structural schematic diagram of a part of the brush head shown in FIG. 14.

FIG. 17 is an exploded structural schematic diagram of the brush head shown in FIG. 14 where a bonding portion thereof is of a step structure.

FIG. 18 is a structural schematic diagram of a part of the brush head shown in FIG. 14 where a bonding portion thereof is of a ridge structure.

FIG. 19 is a structural schematic diagram of an alternative embodiment of the soft elastic piece of the brush head shown in FIG. 14.

FIG. 20 is a structural schematic diagram of a part of the brush head shown in FIG. 14.

FIG. 21 is a front side schematic diagram of the brush head according to another embodiment of the present disclosure.

FIG. 22 is a cross-sectional schematic diagram of a bristle of a friction increasing cluster of the brush head shown in FIG. 21.

FIG. 23 is a perspective schematic diagram of the brush head according to another embodiment of the present disclosure.

FIG. 24 is a perspective schematic diagram of a bristle fixing plate of the brush head shown in FIG. 23.

FIG. 25 is a front side schematic diagram of the bristle fixing plate of the brush head shown in FIG. 23.

In the drawings:

100—electric toothbrush; 10—brush head; 11—brush rod; 111—connecting section; 11a—first rod section; 11b—second rod section; 11c—second step structure; 11c1-second—step surface; 12—brush plate; 12a—12 filling groove; 12b—filling opening; 12a1—first section; 12a2—second section; 121, 60—bristle fixing plate; 121a, 1201, 125, 600—bristle fixing surface; 121b—back surface; 1202—outer back surface; 1203—outer peripheral surface; 121c—peripheral side surface; 121d—bristle fixing hole; 121e, 1205—slot; 122—backplane; 123—connecting portion; 124—bonding portion; 126—edge line; 1221—first connecting end; 1222—second connecting end; 1241—first step structure; 1242-ridge structure; 1243—first step surface; 1251—first area; 1252—second area; 3,30, 40, 50—bristles; 14—soft elastic piece; 14a-inner peripheral surface; 14b-fitting groove; 141—first filling portion; 142—outer soft rubber contour; 143—sleeving portion; 144—second filling portion; 143a—sleeving hole; 1401—protrusion; 15—connecting piece; 20—brush handle assembly; 21—brush handle; 22—circuit board; 23—battery; 24—motor; 30a—first bristle group; 30b—second bristle group; 31—friction increasing cluster; 610—first bristle fixing area; 611—first central bristle fixing hole; 612—first auxiliary bristle fixing area; 620—second bristle fixing area; 621—second central bristle fixing hole; 622—second auxiliary bristle fixing hole; 630—first circumference; 640—second circumference; 650—first reinforcing bristle fixing hole; 660—second reinforcing bristle fixing hole.

Realization of the purpose, functional features, and advantages of the present disclosure are further described with reference to the embodiments and the accompanying drawings.

### DETAILED DESCRIPTION

In order to make the purpose, technical solutions, and advantages of the present disclosure clear, the following section further describes the embodiments of the present disclosure in detail with reference to the accompanying drawings.

### Embodiment 1

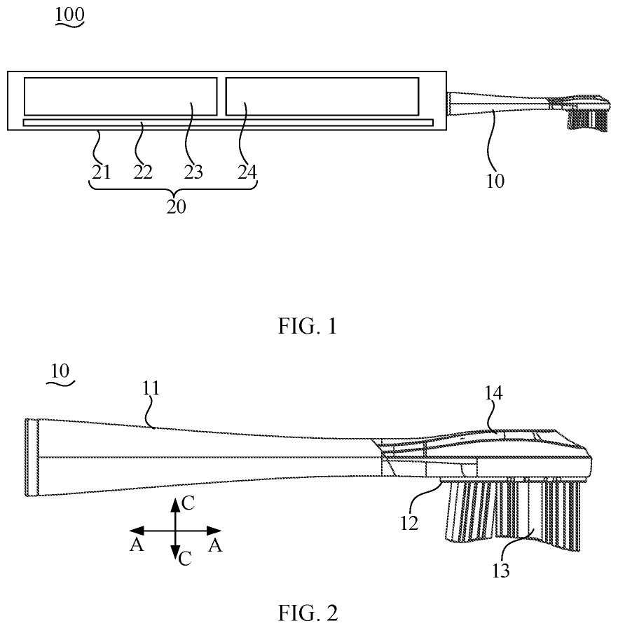

As shown in FIG. 1, in one embodiment, the present disclosure provides an electric toothbrush 100. The electric toothbrush 100 comprises a brush head 10 and a brush handle assembly 20. The brush handle assembly 20 is detachably connected to the brush head 10. The brush handle assembly 20 comprises a brush handle 21 and components, such as a circuit board 22, a battery 23, and a motor 24. The circuit board 22, the battery 23, and the motor 24 are disposed in the brush handle 21. The battery 23 supplies power to the circuit board 22, the motor 24, etc. The circuit board 22 is configured to control the motor 24 to operate. An output shaft of the motor 24 extends out of the brush handle 21 to drive the brush head 10 to vibrate, so that an oral cavity of the user is cleaned through the brush head 10 vibrated by the motor 24.

A vibration frequency of the brush head 10 is relatively high when the motor 24 drives the brush head 10 to vibrate. For instance, the vibration frequency is in a frequency range of 10,000-40,000 times/minute. Within the frequency range, if material of the brush head 10 is hard and the brush head 10 hits teeth or gums, it is easy to bring a bad usage experience to the user and it is also easy to cause damage to the teeth or the gums. In the related art, the brush head is covered with soft rubber to reduce a risk of the brush head hitting the teeth or the gums. However, the brush head is used in a wet and humid environment, a bonding force between the soft rubber and hard plastic is gradually reduced, causing the soft rubber to peel off.

The brush head 10 is detachably connected to the output shaft of the motor 24 to facilitate replacement of different brush heads 10 of different models or materials. It is understood that the brush head 10 in the embodiment of the present disclosure may be applied in manual toothbrushes, which also avoid the damage caused by a conventional brush head to the oral cavity, especially sensitive teeth or sensitive gums.

### Embodiment 2

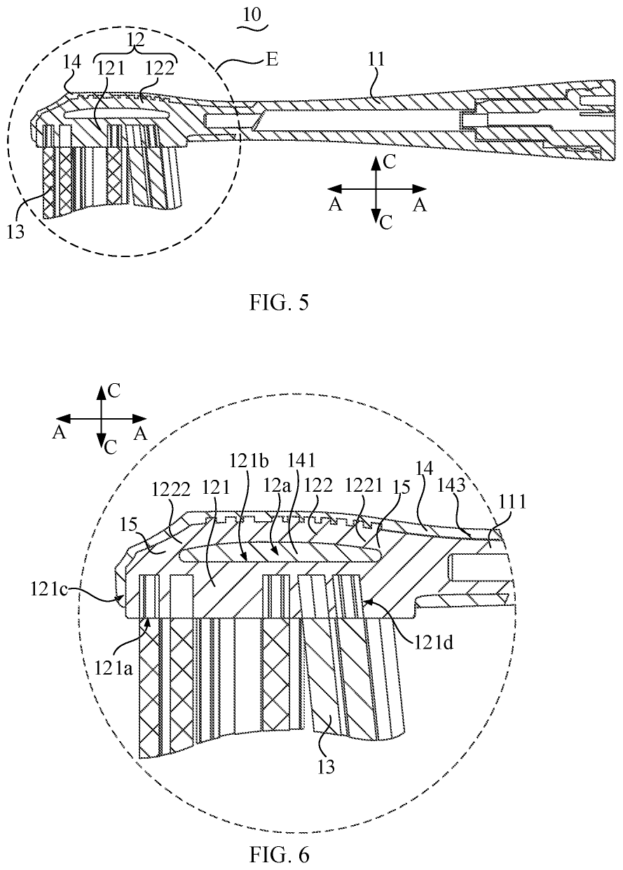

As shown in FIGS. 2-5, in some embodiments, the brush head 10 comprises a brush rod 11, a brush plate 12, bristles 13, and a soft elastic piece 14.

The brush rod 11 is roughly in the shape of an elongated rod. The brush rod 11 defines a length direction AA. A first end of the brush rod 11 is detachably connected to the output shaft of the motor 24, and a second end of the brush rod 11 is connected to the brush plate 12. The brush rod 11 enables the brush head 10 to have a certain length as a whole, so that the brush head 10 is able to reach various parts of the oral cavity that need to be cleaned.

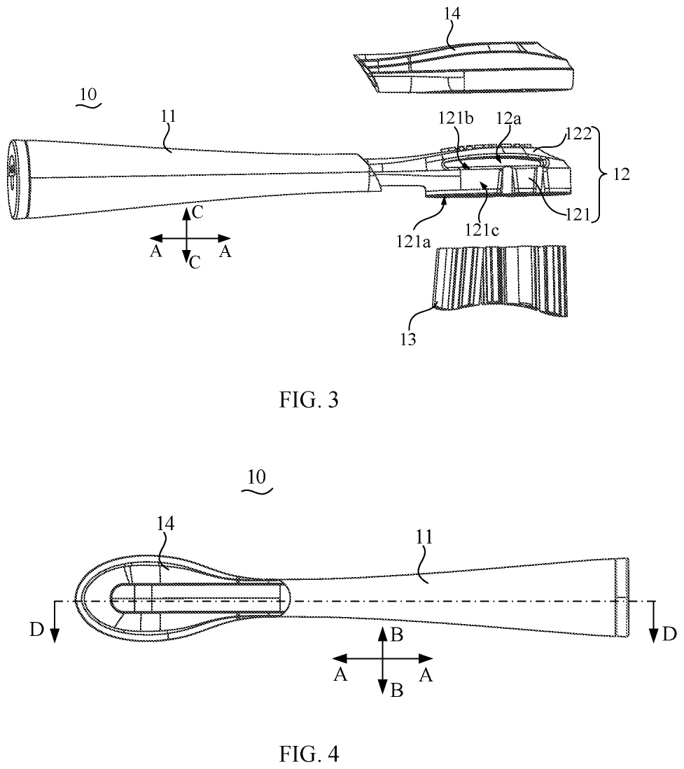

As shown in FIGS. 3-5, the brush plate 12 defines a width direction BB and a thickness direction CC. The width direction BB, the thickness direction CC, and the length direction AA are perpendicular to each other. The brush plate 12 comprises a bristle fixing plate 121 and a back plate 122. The bristles 13, each of which has a proximal end and a free end, and is retained at its proximal within the bristle fixing plate 121. The brush plate 12 is connected to the second end of the brush rod 11 through at least one of the back plate 122 and the bristle fixing plate 121. When only the bristle fixing plate 121 is connected to the brush rod 11, the output shaft of the motor 24 transmits vibration energy to the bristle fixing plate 121 through the brush rod 11. Then the vibration energy is transmitted to the back plate 122 and the bristles 13. When only the back plate 122 is connected to the brush rod 11, the output shaft of the motor 24 transmits the vibration energy to the back plate 122 through the brush rod 11. Then the vibration energy is transmitted to the bristle fixing plate 121 and the bristles 13 in turn. When both of the bristle fixing plate 121 and the back plate 122 are connected to the brush rod 11, the output shaft of the motor 24 transmits the vibration energy to the bristle fixing plate 121 and the back plate 122 through the brush rod 11, and then the vibration energy is transmitted to the bristles 13 through the bristle fixing plate 121.

As shown in FIG. 6, the bristle fixing plate 121 is roughly of a plate structure and is configured to fix the bristles 13. The bristle fixing plate 121 comprises a bristle fixing surface 121a and a back surface 121b. The back surface 121b of the bristle fixing plate 121 is opposite to the bristle fixing surface 121a of the bristle fixing plate 121. The bristles 13 are extended from the bristle fixing surface 121a of the bristle fixing plate 121. That is, the bristle fixing surface 121a of the bristle fixing plate 121 is a surface where the bristles 13 passing through from an interior of the bristle fixing plate 121. The back surface 121b of the bristle fixing plate 121 is opposite to the bristle fixing surface 121a of the bristle fixing plate 121 and faces the back plate 122. When a user brushes his or her teeth, the bristle fixing surface 121a of the bristle fixing plate 121 is a surface facing the teeth of the user, and the back surface 121b of the bristle fixing plate 121 is a surface facing away from the teeth of the user. Further, the bristle fixing plate 121 comprises a peripheral side surface 121c located between the bristle fixing surface 121a and the back surface 121b.

The back plate 122 is disposed on one side of the bristle fixing plate 121 away from the bristles 13. Namely, the back plate 122 faces the back surface 121b of the bristle fixing plate 121. A portion of the back plate 122 is spaced apart from the back surface 121b of the bristle fixing plate 121 to define a filling groove 12a. The soft elastic piece 14 is filled in the filling groove 12a, so as to improve connection stability between the soft elastic piece 14 and the brush plate 12. Furthermore, the back plate 122 comprises a first connecting end 1221 close to the brush rod 11 and a second connecting end 1222 away from the brush rod 11 along the length direction AA. The back plate 122 is connected to the bristle fixing plate 121 through at least one of the first connecting end 1221 and the second connecting end 1222 of the back plate 122, so that the back plate 122 and the bristle fixing plate 121 are fixedly connected.

As shown in FIGS. 2-7, the soft elastic piece 14 roughly covers the back plate 122, so that the back plate 122 is roughly not exposed. When the user brushes his or her teeth, a back portion of the brush head 10 is in contact with the oral cavity of the user, such as the teeth or the gums, through the soft elastic piece 14 rather than the back plate 122. During high-frequency vibration of the brush head 10, because the soft elastic piece 14 is made of soft material and is prone to elastic deformation, the soft elastic piece 14 provides a good cushioning effect and effectively protect the oral cavity of the user.

Furthermore, as shown in FIGS. 3 and 6, the soft elastic piece 14 is filled in the filling groove 12a, and the soft elastic piece 14 also covers the back plate 122, thereby increasing contact areas between the soft elastic piece 14, the bristle fixing plate 121 and the back plate 122, increasing overall connection stability between the soft elastic piece 14 and the brush plate 12, and reducing a risk of the soft elastic piece 14 peeling off from the brush plate 12.

Furthermore, as shown in FIG. 6, the soft elastic piece 14 covers on at least a part of the peripheral side surface 121c of the bristle fixing plate 121.

In this way, at least the part of the peripheral side surface 121c of the bristle fixing plate 121 of the brush head 10 is in contact with the oral cavity of the user, such as the teeth or the gums, through the soft elastic piece 14, rather than directly contacting the oral cavity of the user directly through the peripheral side surface 121c of the bristle fixing plate 121. During the high-frequency vibration of the brush head 10, because the soft elastic piece 14 is made of the soft material and is prone to elastic deformation, the soft elastic piece 14 provides the good cushioning effect and effectively protect the oral cavity of the user. For instance, the soft elastic piece 14 covers a circle area of the peripheral side surface 121c of the bristle fixing plate 121 or completely covers the peripheral side surface 121c of the bristle fixing plate 121, which increases a contact area between the soft elastic piece 14 and the peripheral side surface 121c of the bristle fixing plate 121, thereby improving the connection stability between the soft elastic piece 14 and the bristle fixing plate 121, and preventing the soft elastic piece 14 from peeling off from the brush plate 12.

In summary, the portion of the back plate 122 is spaced apart from the back surface 121b of the bristle fixing plate 121 to define the filling groove 12a. The soft elastic piece 14 is disposed to cover the back plate 121 and fill the filling groove 12a. The soft elastic piece 14 further covers the back surface 121b of the bristle fixing plate 121, and the soft elastic piece 14 at least covers the part of the peripheral side surface 121c of the bristle fixing plate 121. Therefore, the brush head 10 of the present disclosure has two characteristics.

First, in terms of the cushioning effect, since the soft elastic piece 14 covers the back plate 122 and the back surface 121b of the bristle fixing plate 121, the back portion of the brush head 10 contacts the oral cavity of the user through the soft elastic piece 14. The soft elastic piece 14 at least covers the part of the peripheral side surface 121c of the bristle fixing plate 121, so that the peripheral side surface 121c of the bristle fixing plate 121 of the brush head 10 contacts the oral cavity of the user through the soft elastic piece 14, and a front side of the brush head 10 contacts the oral cavity of the user through the bristles 13. In summary, except that the bristles 13 are in contact with the oral cavity of the user, the bristle fixing plate 121 is hardly in contact with the oral cavity of the user, and the back plate 122 is not in contact with the oral cavity of the user. That is, the brush head 10 is in contact with the oral cavity of the user through the soft elastic piece 14 except for the front side thereof where the bristles 13 are disposed. Since the soft elastic piece 14 is made of the soft material and prone to elastic deformation, the soft elastic piece 14 has the good cushioning effect and the oral cavity of the user is effectively protected.

Second, in terms of the connection stability of the soft elastic piece 14 and the brush plate 12, since the soft elastic piece 14 is filled in the filling groove 12a, and the filling groove 12a is formed by spacing apart the back plate 122 from the bristle fixing plate 121 along the thickness direction CC of the brush plate 12, the filling groove 12a and the soft elastic piece 14 are mutually limited, so that the soft elastic piece 14 is unable to be loosened along the thickness direction CC of the brush plate 12, and the soft elastic piece 14 is not peeled off from the brush plate 12. Moreover, since the soft elastic piece 14 at least covers the part of the peripheral side surface 121c of the bristle fixing plate 121, the peripheral side surface 121c of the bristle fixing plate 121 and the soft elastic piece 14 are also mutually limited, so that the soft elastic piece 14 is not loosened along any direction in a plane where the brush plate 12 is located, nor the soft elastic piece 14 being peeled off from the brush plate 12. In addition, the soft elastic piece 14 may be formed by injection molding on the brush plate 12 to fill the filling groove 12a and cover the back plate 122, the back surface 121b, and at least the part of the peripheral side surface 121c of the bristle fixing plate 121, so that there is a strong bonding force between the soft elastic piece 14, the back plate 122, and the bristle fixing plate 121. Therefore, there is the good connection stability between the soft elastic piece and the brush plate. Even if the brush head 10 is used for a long time in a high-frequency vibration scenario, the soft elastic piece 14 is hardly peeling off from the brush plate 12.

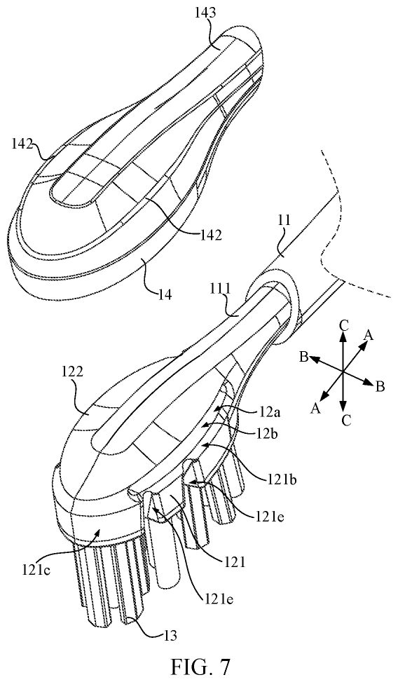

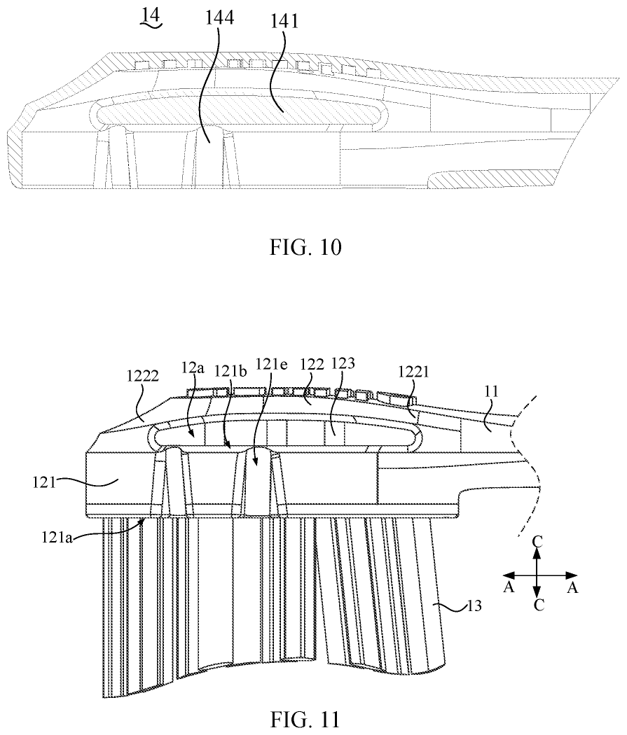

As shown in FIGS. 7-10, in some embodiments, the filling groove 12a penetrates through the brush plate 12 in the width direction BB to form two filling openings 12b opposite to each other in the width direction BB. The two filling openings 12b allow injecting liquid to flow into the filling groove 12a during an injection molding process, and the injecting liquid is solidified in the filling groove 12a to form a first filling portion 141. The soft elastic piece 14 comprises the first filling portion 141. The two filling openings 12b opposite to each other are defined on the brush plate 12 along the width direction BB, and the two filling openings 12b are communicated with the filling groove 12a. During the injection molding process, the fe liquid flows into the filling groove 12a from the two filling openings 12b and fills the filling groove 12a. After the injecting liquid solidifies, a portion of the soft elastic piece in the filling groove 12a forms the first filling portion 141. The first filling portion 141 is sandwiched between the bristle fixing plate 121 and the back plate 122, and is protected and limited by the bristle fixing plate 121 and the back plate 122. The first filling portion 141 is directly connected to a groove wall of the filling groove 12a, thereby increasing connection stability between the first filling portion 141 and the brush plate 12. The first filling portion 141 is integrated with other portions of the soft elastic piece 14 by injection molding, which enhances the connection stability between the soft elastic piece 14 and the brush plate 12.

It is noted that in the embodiments of the present disclosure, the soft elastic piece may be made from rubber, silicon, or other flexible material, which is not limited thereto. Similarly, the injecting liquid are rubber liquid, silicone liquid, or other liquid capable of being solidified into the soft elastic piece, which is not limited thereto.

By defining the two filling openings 12b, a speed of the injecting liquid flowing into the filling groove 12a is increased. In addition, the two filling openings 12b are opposite to each other, allowing the injecting liquid to flow between the two filling openings 12b, so that the injecting liquid can fill the filling groove 12a. If only one filling opening 12b is provided, and the injecting liquid flows from the one filling opening 12b, due to a surface tension of the injecting liquid, the injecting liquid may directly block the one filling opening 12b, causing air in the filling groove 12a being unable to discharge, which eventually leads to a result that the injecting liquid to be unable to completely fill the filling groove 12a. If two or more filling openings 12b communicated with each other are provided, such problem is avoided. The injecting liquid covers the peripheral side surface 121c of the bristle fixing plate 121 while filling in the filling groove 12a or the injecting liquid covers the peripheral side surface 121c of the bristle fixing plate 121 after filling in the filling groove 12a, which not only realizes injection of the injecting liquid in the filling groove 12a, but also realizes coating of the peripheral side surface 121c of the bristle fixing plate 121. Further, an injection process of the injecting liquid is easy, an overall structure of the soft elastic piece 14 is simple, and the soft elastic piece 14 is easy to form.

It should be noted that the filling groove 12a may also penetrate the brush plate 12 in another direction, such as the length direction AA, to form the two filling openings 12b opposite to each other.

As shown in FIG. 7, in some embodiments, in the thickness direction CC of the brush plate 12, a thickness of the soft elastic piece 14 at the filling openings 12b is greater than a thickness of other positions of the soft elastic piece 14, so as to form outer soft rubber contours 142 on the back portion of the brush head 10. By forming the outer soft rubber contours 142 on the back portion of the brush head 10, the thickness of the soft elastic piece 14 at the outer soft rubber contours 142 is greater than the thickness of the soft elastic piece 14 at other positions. When the user brushes his or the teeth, a back portion of the soft elastic piece 14 contacts the oral cavity of the user through the outer soft rubber contours 142. By defining the outer soft rubber contours 142, a contact area between the soft elastic piece 14 and the oral cavity is reduced, and the soft elastic piece 14 is more prone to deformation. Therefore, when the back portion of the soft elastic piece 14 is in contact with the oral cavity of the user, the soft elastic piece 14 effectively buffers the vibration and prevents the brush head 10 from vigorously hitting the teeth, so that the brush head 10 effectively protects the teeth.

As shown in FIGS. 6-8, in some embodiments, the brush rod 11 comprises a connecting section 111 connected to the brush plate 12. The connecting section 111 is connected to at least one of the bristle fixing plate 121 and the back plate 122. The soft elastic piece 14 is also sleeved on the connecting section 111 in a ring shape. That is, the soft elastic piece 14 comprises a sleeving portion 143, and the sleeving portion 143 is sleeved on the connecting section 111. In this way, the soft elastic piece 14 is prevented from peeling off the brush rod 11 along a radial direction thereof

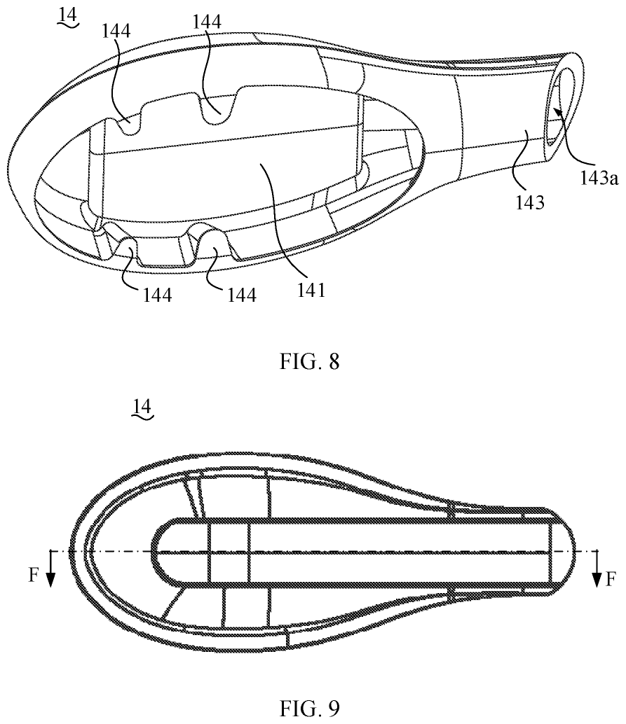

Furthermore, as shown in FIG. 8, the sleeving portion 143 defines a sleeving hole 143a. The connecting section 111 is inserted into the sleeving hole 143a. A diameter of the sleeving hole 143a is less than a width of the brush plate 12 along the width direction BB. Since the brush plate 12 blocks the sleeving portion 143, the sleeving portion 143 is unable to peel off from the connecting section 111 along the length direction AA. Therefore, the connection stability between the soft elastic piece 14, the brush plate 12, and the brush rod 11 is further enhanced.

As shown in FIG. 6, in some embodiments, along the length direction AA, the filling groove 12a has a first length, the bristle fixing plate 121 has a second length, and a ratio of the first length of the filling groove 12a to the second length of the bristle fixing plate 121 is not less than 0.5. In this way, the filling groove 12a and the portion of the soft elastic piece filled in the filling groove 12a (i.e., the first filling portion 141) have a relative long length, which not only provides a larger cushioning range, but also increases a connection area between the first filling portion 141 and the groove wall of the filling groove 12a. That is, a connection area between the back surface 121b of the bristle fixing plate 121 and an inner wall surface of the back plate 122 is increased, thereby enhancing the connection stability between the first filling portion 141, the bristle fixing plate 121, and the back plate 122.

In addition, the longer the filling groove 12a is, the easier the bristle fixing plate 121 and the back plate 122 are prone to deformation, thereby reducing the risk of biting the teeth, making it easier for the bristles 13 disposed on the bristle fixing plate 121 to fit surfaces of the teeth of the user and improving a tooth cleaning effect.

As shown in FIG. 6, in some embodiments, along the thickness direction CC of the brush plate 12, a maximum thickness of the filling groove 12a is not less than 2 mm and no more than 5 mm, so that the filling groove 12a has an appropriate thickness. On the one hand, the thickness of the filling groove 12a is large enough, so that the injecting liquid can flow into the filling groove 12a relatively easily and fill the filling groove 12a during the injection molding process. On the other hand, the maximum thickness of the filling groove 12a is not that large, so that the brush head 10 has the appropriate thickness, which reduces discomfort brought to the user after the brush head 10 is placed in the oral cavity.

If the maximum thickness of the filling groove 12a is less than 2 mm, it may be difficult for the injecting liquid to flow into the filling groove 12a and fill the filling groove 12a during the injection molding process. There is a risk that there are bubble in the filing groove 12a since the filling groove 12a is unable to be filled by the soft elastic piece 14. Furthermore, if the maximum thickness of the filling groove 12a is less than 2 mm, a thickness of the first filling portion 141 is also less than 2 mm, and the first filling portion 141 is easily damaged, causing the soft elastic piece 14 being easily peeling off from the brush plate 12.

If the maximum thickness of the filling groove 12a is greater than 5 mm, the thickness of the filling groove 12a is too large, and an overall thickness of the brush head 10 is determined by combination of the thickness of the filling groove 12a, the thickness of the bristle fixing plate 121, and a thickness of the back plate 122. As a result, the overall thickness of the brush head 10 is too large, when putting the brush head into the oral cavity, the user needs to open his or her mouth wide, which brings discomfort to the user. Moreover, the brush head that is too thick increases the risk of hitting the teeth.

As shown FIG. 7, in some embodiments, along the width direction BB of the brush plate 12, the back plate 122 has a first width, and the bristle fixing plate 121 has a second width. The first width of the back plate 122 is less than the second width of the bristle fixing plate 121. That is, a width of the back plate 122 is less than the width of the bristle fixing plate 121. In this way, a size of the filling groove 12b is large, which makes it easier for the injecting liquid to flow into the filling groove 12a during the injection molding process, and enables the filling groove 12b to receive more soft rubber, thus bringing a better cushioning effect.

As shown in FIG. 6, in some embodiments, along the thickness direction CC of the brush plate 12, the back plate 122 has a first thickness, the bristle fixing plate 121 has a second thickness, and the first thickness of the back plate 122 is less than the second thickness of the bristle fixing plate 121. That is, the thickness of the back plate 122 is less than the thickness of the bristle fixing plate 121, so that roots of the bristles 13 (i.e., the proximal end of each of the bristles) are deeper and longer fixed in the bristle fixing plate 121, thereby improving connection stability between the bristles 13 and the bristle fixing plate 121. In addition, the thickness of the back plate 122 is less than the thickness of the bristle fixing plate 121, so that the overall thickness of the brush head 10 is effectively reduced.

As shown in FIG. 6, in some embodiments, along the thickness direction CC of the brush plate 12, the thickness of the brush plate 12 (that is, a total thickness of the bristle fixing plate 121, the filling groove 12a, and the back plate 122) is not less than 3.5 mm and no more than 7 mm, so that the brush plate 12 has a relatively suitable thickness. In such thickness range, on one hand, the thickness of the bristle fixing plate 121, the thickness of the filling groove 12a, and the thickness of the back plate 122 are reasonably determined, so that the bristle fixing plate 121 has a relative thick thickness to fix the bristles 13, the filling groove 12a has a relative thick thickness to receive the first filling portion 141, and the back plate 122 has strong strength and is not easy to break. On the other hand, the thickness of the brush plate 12 is not too large, so that a total thickness of the soft elastic piece 14 and the brush plate 12 is not too large.

If the thickness of the brush plate 12 is less than 3.5 mm, it means that an overall thickness of the brush plate 12 is too thin, and at least one of the bristle fixing plate 121, the filling groove 12a, and the back plate 122 is too thin. If the bristle fixing plate 121 is too thin, a bristle fixing process is not facilitated. Specifically, the bristle fixing process is extremely difficult to process, and fixing performance of the bristles 13 is not satisfying. If the filling groove 12a is too thin, it is inconvenient to form the first filling portion 141, for instance, the injecting liquid may not fill the filling groove 12a to form the first filling portion or the first filling portion 141 may be too thin, such that the connection stability between the soft elastic piece 14 and the brush plate 12 is reduced. If the back plate 122 is too thin, the back plate 122 is insufficient in strength and easy to break.

If the thickness of the brush plate 12 is greater than 7 mm, it means that the thickness of the brush plate 12 is too large. That is, the total thickness of the soft elastic piece 14 and the brush plate 12 is too large.

As shown in FIG. 6, in some embodiments, along the thickness direction CC of the brush plate 12, the bristle fixing surface 121a of the bristle fixing plate 121 protrudes from the soft elastic piece 14 relative to the soft elastic piece 14, so that the peripheral side surface 121c of the bristle fixing plate 121 is partially exposed to the soft elastic piece 14. Namely, the soft elastic piece 14 only wraps the part of the peripheral side surface 121c of the bristle fixing plate 121 close to the back surface 121b, and an area of the peripheral side surface 121c close to the bristle fixing surface 121a of the bristle fixing plate 121 is not wrapped by the soft elastic piece 14. That is, the soft elastic piece 14 does not completely wraps the peripheral side surface 121c of the bristle fixing plate 121, and the area of the peripheral side surface 121c and the bristle fixing surface 121a of the bristle fixing plate 121 are exposed to the soft elastic piece 14. In this way, in the injection molding process, the injecting liquid does not flow to the bristle fixing surface 121a to block bristle fixing holes 121d, and does not affect the bristle fixing.

As shown in FIG. 11, in some embodiments, the back plate 122 is connected to the bristle fixing plate 121 through the first connecting end 1221 and the second connecting end 1222 thereof. The filling groove 12a is defined between the first connecting end 1221 and the second connecting end 1222 of the back plate 122. In this way, the first connecting end 1221 and the second connecting end 1222 of the back plate 122 are connected to the bristle fixing plate 121 to realize multi-point connection, which enhances the connection stability between the back plate 122 and the bristle fixing plate 121. In addition, the first connecting end 1221 and the second connecting end 1222 of the back plate 122 are disposed in sequence along the length direction AA. The first filling portion 141 is disposed in the filling groove 12a. The first connecting end 1221 and the second connecting end 1222 of the back plate 122 avoid the first filling portion 141 from moving along the length direction AA, thereby improving the connection stability between the soft elastic piece 14 and the brush plate 12.

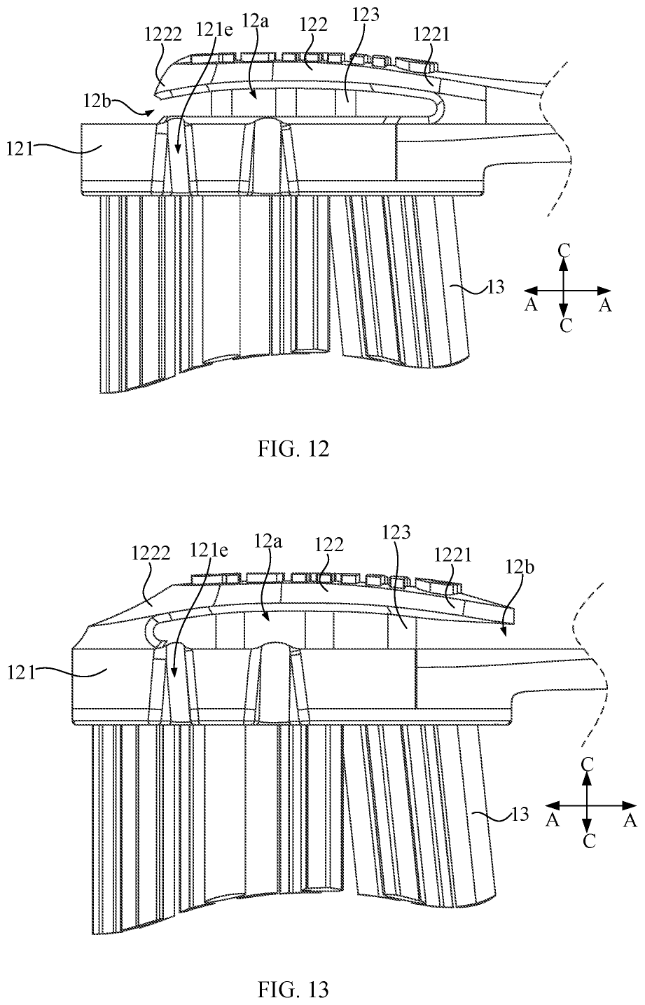

As shown in FIG. 12, in other alternative embodiments, the back plate 122 is connected to the bristle fixing plate 121 through the first connecting end 1221 thereof. The second connecting end 1222 of the back plate 122 is suspended. The filling openings 12b are defined between the second connecting end 1222 of the back plate 122 and the back surface 121b of the bristle fixing plate 121. In combination with the foregoing embodiments, the filling groove 12a penetrates through the brush plate 12 in the width direction BB to form the filling openings 12b opposite to each other. At this time, except that the first connecting end 1221 of the back plate is connected to the bristle fixing plate 121, other positions of the back plate 122 are not connected to the bristle fixing plate 121 to define the filling groove 12a. Except for one side where the first connecting end 1221 of the back plate 122 is located, other sides of the filling groove 12a is not sealed to define the filling openings 12b, so that the injecting liquid more quickly flows into the filling groove and fully fills the filling groove 12a.

As shown in FIG. 13, in other alternative embodiments, the back plate 122 is connected to the bristle fixing plate 121 through the second connecting end 1222 thereof. The first connecting end 1221 of the back plate 122 is suspended, and the filling openings 12b is defined between the first connecting end 1221 of the back plate 122 and the back surface 121b of the bristle fixing plate 121.

In combination with the foregoing embodiments, the filling groove 12a penetrates through the brush plate 12 in the width direction BB to form the filling openings 12b opposite to each other. At this time, except that the second connecting end 1222 of the back plate 122 is connected to the bristle fixing plate 121, other positions of the back plate 122 are not connected to the bristle fixing plate 121 to define the filling groove 12a. Except for one side where the second connecting end 1222 of the back plate 122 is located, other sides of the filling groove 12a is not sealed to define the filling openings 12b, so that the injecting liquid more quickly flows into the filling groove and fully fills the filling groove 12a.

As shown in FIGS. 11-13, in some embodiments, the brush plate 12 further comprises at least one connecting portion 123 disposed in the filling groove 12a. The at least one connecting portion 123 connects the back surface 121b of the bristle fixing plate 121 to the back plate 122. The back plate 122 and the bristle fixing plate 121 are connected through the at least one connecting portion 123, which improves a connection strength between the back plate 122 and the bristle fixing plate 121, and reduce the risk of the back plate 122 peeling off from the bristle fixing plate 121.

Because the back plate 122 is also extended along the length direction AA, when a plurality of connecting portions 123 are provided, the plurality of connecting portions 123 are disposed at intervals along the length direction AA to connect the back plate 122 to the bristle fixing plate 121. That is, the plurality of connecting portions 123 are disposed along the length direction AA and are connected to the back plate 122 and the bristle fixing plate 121 in a multi-point manner, so that multi-point support is realized in a middle portion of the back plate 122, preventing the back plate 122 from being broken from the middle portion thereof. In particular, when the back plate 122 is only connected to the bristle fixing plate 121 through the first connecting end 1221 or the second connecting end 1222, one of the first connecting end 1221 and the second connecting end 1222 is in a suspended state, and the first connecting end 1221 or the second connecting end 1222 thereof connected to the bristle fixing plate 121 is easier to break. By providing the at least one connecting portion 123, a stress of the first connecting end 1221 or the second connecting end 1222 is dispersed, so the back plate 122 is not easily peeled off from the bristle fixing plate 121 due to breakage.

In addition, the plurality of connecting portions 123 further limit the first filling portion 141 filled between the plurality of connecting portions 123, so the first filling portion 141 is firmly fixed in the filling groove 12a, and the soft elastic piece 14 with the first filling portion 141 is less prone to peeling off from the brush plate 12.

As shown in FIG. 3, in some embodiments, the bristle fixing plate 121 and the back plate 122 are integrally formed. In this way, not only a connection process between the bristle fixing plate 121 and the back plate 122 is simplified, but also the connection stability between the bristle fixing plate 121 and the back plate 122 is improved. In addition, a one-piece component (i.e., the bristle fixing plate 121 and the back plate 122) has fewer molding times, high processing efficiency, and excellent dimensional consistency.

In some embodiments, the bristle fixing plate 121 and the brush rod 11 are integrally formed. In this way, not only a connection process between the bristle fixing plate 121 and the brush rod 11 is simplified, but also the connection stability between the bristle fixing plate 121 and the brush rod 11 is improved. In addition, a one-piece component (i.e., a combination of the bristle fixing plate 121 and the brush rod 11) has fewer molding times, high processing efficiency, and excellent dimensional consistency.

In some embodiments, the back plate 122 and the brush rod 11 are integrally formed. In this way, not only a connection process between the back plate 122 and the brush rod 11 is simplified, but also the connection stability between the back plate 122 and the brush rod 11 is improved. In addition, a one-piece component (i.e., a combination of the back plate 122 and the brush rod 11) has fewer molding times, high processing efficiency, and excellent dimensional consistency.

In some embodiments, the bristle fixing plate 121, the back plate 122, and the brush rod 11 are integrally formed. In this way, not only a connection process between the bristle fixing plate 121, the back plate 122, and the brush rod 11 is simplified, but also the connection stability between the bristle fixing plate 121, the back plate 122, and the brush rod 11 is improved. In addition, the one-piece component (i.e., a combination of the bristle fixing plate 121, the back plate 122, and the brush rod 11) has fewer molding times, high processing efficiency, and excellent dimensional consistency.

In some embodiments, the bristle fixing plate 121 and the back plate 122 are separated pieces. That is, the bristle fixing plate 121 and the back plate 122 are separately manufactured and then connected together. One of the bristle fixing plate 121 and the back plate 122 is integrally formed with the brush rod 11, thereby simplifying the connection process between the bristle fixing plate 121 or the back plate 122 and the brush rod 11, and improving the connection process between the bristle fixing plate 121 or the back plate 122 and the brush rod 11. Furthermore, as shown in FIG. 6, the brush head 10 further comprises a connecting piece 15. The connecting piece 15 is integrally formed with the bristle fixing plate 121. At least one of the first connecting end 1221 and the second connecting end 1222 of the back plate 122 is connected to the bristle fixing plate 121 through the connecting piece 15. A hardness of the connecting piece 15 and a hardness of the bristle fixing plate 121 is no more than a hardness of the soft elastic piece 14. In this way, the bristle fixing plate 121 is more prone to elastic deformation, so that the bristles 13 on the bristle fixing plate 121 are fitter to the teeth, thereby bringing a better tooth cleaning effect.

In some embodiments, the bristle fixing plate 121 and the back plate 122 are separated pieces. The bristle fixing plate 121 and the brush rod 11 are integrally connected, the back plate 122 is connected to the bristle fixing plate 121 through the connecting piece 15, and the connecting piece 15 is harder than the soft elastic piece 14 or the connecting piece 15 is made of the same material as the software rubber piece 14.

Alternatively, the bristle fixing plate 121 and the back plate 122 are separated pieces, the back plate 122 and the brush rod 11 are integrally connected, the bristle fixing plate 121 is an independent piece, and the bristle fixing plate 121 is connected to the back plate 122 through the connecting piece 15. The connecting piece 15 is harder than the soft elastic piece 14 or the connecting piece 15 is made of the same material as the software rubber piece 14. The bristle fixing plate 121 and the back plate 122 are separated pieces, making a manufacturing process flexible. The material of the connecting piece 15 is selected to be soft to provide a better cushioning effect.

As shown in FIG. 6, in some embodiments, bristle fixing holes 121d are defined on the bristle fixing surface 121a of the bristle fixing plate 121. The bristle fixing holes 121d are blind holes. The brush head 10 further comprises a copper sheets (not shown in the drawings), and the roots of the bristles 13 are fixed in the bristle fixing holes 121d through the copper sheets. That is, the bristle fixing holes 121d do not penetrate through the bristle fixing plate 121 along the thickness direction CC, and the bristles 13 are fixed on the bristle fixing plate 121 through a copper bristle fixing process, so that the bristle fixing plate 121 is thin. Further, a reinforcing effect of the bristle fixing plate 121 is superimposed with the reinforcing effect of the back plate 122 and the soft elastic piece 14, which ensures a structure strength of the brush plate 12 and allows the brush head 10 being not too thick.

In addition, assuming that there is no through hole served as bristle ironing space if the bristle fixing plate 121 and the back plate 122 are not spaced, a copper-free bristle fixing process is adopted, a proportion of the bristle fixing surface 121a of the bristle fixing plate 121 is reduced, and an vacant edge of the bristle fixing plate 121 is too large, thereby affecting the cleaning effect of the oral cavity. Instead, in the embodiment, a copper bristle fixing process is adopted, as many bristle fixing holes 121d as possible are defined on the bristle fixing surface 121a of the bristle fixing plate 121, and as many bristles 13 as possible are fixed in the bristle fixing surface 121a, so a bristle density of the bristle fixing surface 121a of the bristle fixing plate 121 is increased, thereby improving tooth cleaning efficiency of the brush head 10.

In addition, by the copper bristle fixing process, there is no need to leave the bristle ironing space at a connection position between the bristle fixing plate 121 and the back plate 122, so that the bristle fixing plate 121 and the back plate 122 can be integrally formed, which simplifies the connection process of the bristle fixing plate 121 and the back plate 122, and improves the connection strength between the bristle fixing plate 121 and the back plate 122.

In some alternative embodiments, the bristle fixing holes 121d are defined on the bristle fixing surface 121a of the bristle fixing plate 121. The bristle fixing holes 121d are through holes, the roots of the bristles 13 are inserted into the bristle fixing holes 121d, and portions of roots of the bristles 13 passing through the back surface 121b of the bristle fixing plate 121 are melted with the bristle fixing plate 121 (i.e., the portions of the roots of the bristles 13 passing through the back surface 121b of the bristle fixing plate 121 are melted by an ironing process, and are connected to the back surface 121b of the bristle fixing plate 121), thereby fixing the bristles 13 on the bristle fixing plate 121.

Furthermore, when the bristle fixing plate 121 and the back plate 122 are the separated pieces, the bristle fixing holes 121d are also defined on the connection position of the back plate 122 and the bristle fixing plate 121 for fixing the bristles. After a bristle fixing process is completed, the bristle fixing plate 121 is connected to the back plate 122. Therefore, as many bristle fixing holes 121d as possible are defined on the bristle fixing surface 121a of the bristle fixing plate 121, and as many bristles 13 as possible are fixed in the bristle fixing surface 121a, so the bristle density of the bristle fixing surface 121a of the bristle fixing plate 121 is increased, thereby improving the tooth cleaning efficiency of the brush head 10.

If the bristle fixing plate 121 and the back plate 122 are integrally formed, the bristle fixing holes 121d cannot be defined at the position of the bristle fixing plate 121 where the bristle fixing plate 121 and the back plate 122 are connected. Namely, the portions of the roots of the bristles 13 passing through the back surface 121b of the bristle fixing plate 121 cannot be melted with the bristle fixing plate 121, resulting in a decrease in the bristle density.

In addition, by the copper-free bristle fixing process (i.e., the copper sheets are not used, and the bristles are connected to the bristle fixing plate 121 through a hot-melt method), requirement for the thickness of the bristle fixing plate 121 is reduced, the bristle fixing plate 121 is allowed to be softer and thinner, cushioning performance of the bristles 13 are better, the bristles 13 fit the teeth better, which bring a better tooth brushing comfort to the user.

As shown in FIGS. 7-11, in some embodiments, at least one slot 121e is defined on the peripheral side surface 121c of the bristle fixing plate 121. Two ends of the at least one slot respectively extend to the bristle fixing surface 121a of the bristle fixing plate 121 and the back surface 121b of the bristle fixing plate 121. The at least one slot 121e is communicated with the filling groove 12a. The soft elastic piece 14 further comprises at least one second filling portion 144 filled in the at least one slot 121e. That is, during the injection molding process, the injecting liquid not only fills the filling groove 12a to form the first filling portion 141, but also fills the at least one slot 121e to form the at least one second filling portion 144. Therefore, a connection area between the soft elastic piece 14 and the bristle fixing plate 121 is increased, and the connection stability between the soft elastic piece 14 and the bristle fixing plate 121 is improved. Moreover, the at least one slot 121e and the soft elastic piece 14 are mutually limited, so that the soft elastic piece 14 is prevented from loosening relative to the bristle fixing plate 121. The at least one slot 121e also improves bending deformation capability of the bristle fixing plate 121 and improve the cushioning effect. In one embodiment, slots are provided, and the slots 121e are disposed at intervals.

As shown in FIG. 7, in some embodiments, the at least one slot 121e has slot cross sections perpendicular to the thickness direction CC of the brush plate 12. The slot cross sections gradually increase in a direction from the back surface 121b to the bristle fixing surface 121a of the bristle fixing plate 121. In other words, the slot cross sections gradually decreases in a direction from the bristle fixing surface 121a to the back surface 121b of the bristle fixing plate 121. Accordingly, cross sections of the at least one second filling portion 144 gradually decreases in the direction from the bristle fixing surface 121a to the back surface 121b of the bristle fixing plate 121, so that after the soft elastic piece 14 covers the peripheral side surface 121c of the bristle fixing plate 121, the more the soft elastic piece 14 moves toward the back portion of the brush head 10, the greater an interaction force squeezing degree of the at least one second filling portion 144 and the at least one slot 121e is, and the greater a binding force between the soft elastic piece 14 and the brush plate 12 is.

As shown in FIG. 7, in some embodiments, the peripheral side surface 121c of the bristle fixing plate 121 comprises two sub-side surfaces located on two opposite sides of a central axis of the brush rod 11. Each of the sub-side surfaces of the bristle fixing plate 121 defines the slots 121e, so that the soft elastic piece 14 is connected to the bristle fixing plate 121 at a plurality of positions thereof by filling the slots 121e, thus further improving the connection stability between the soft elastic piece 14 and the bristle fixing plate 121.

Furthermore, as shown in FIGS. 7-11, the bristle fixing plate 121 comprises a free end away from the brush rod 11, sizes of the slots 121e close to the free end of the bristle fixing plate 121 are less than sizes of the slots 121e located in middle portions of the sub-side surfaces of the bristle fixing plate 121. The slots 121e on the middle portions of the sub-side surfaces of the bristle fixing plate 121 are larger in size, so that the bristle fixing plate 121 deforms more easily on the middle portions of the sub-side surfaces of the bristle fixing plate 121, which improves the cushioning effect. The slots 121e close to the free end of the bristle fixing plate 121 are smaller in size, which leaves more area as the bristle fixing surfaces 121a of the bristle fixing plate 121, improves the bristle density, and improve the tooth cleaning effect.

The above content describes the structure of the brush head 10 that protects the oral cavity and comprises the soft elastic piece 14 and the brush plate 12 that are firmly connected. However, the structure of the brush head 10 that protects the oral cavity is not limited as mentioned above. The brush head 10 that protects the oral cavity and comprises the soft elastic piece 14 and the brush plate 12 that are firmly connected according to another embodiment is disclosed as follow.

### Embodiment 3

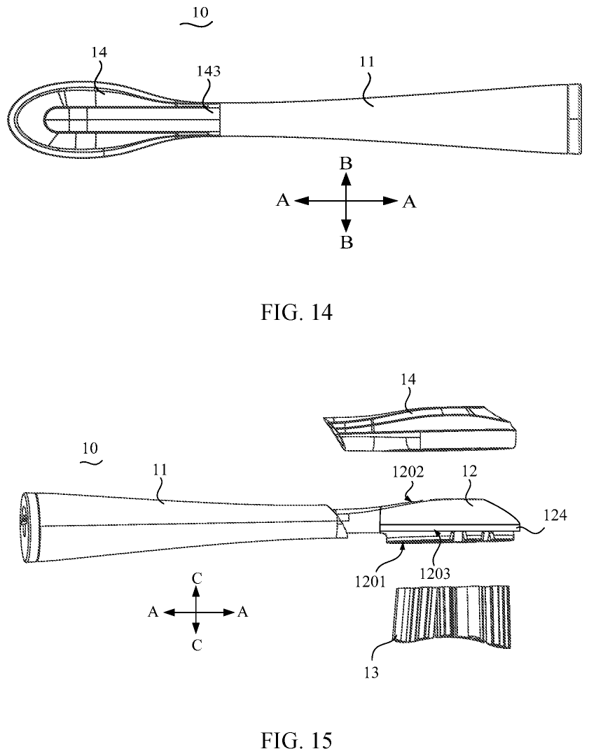

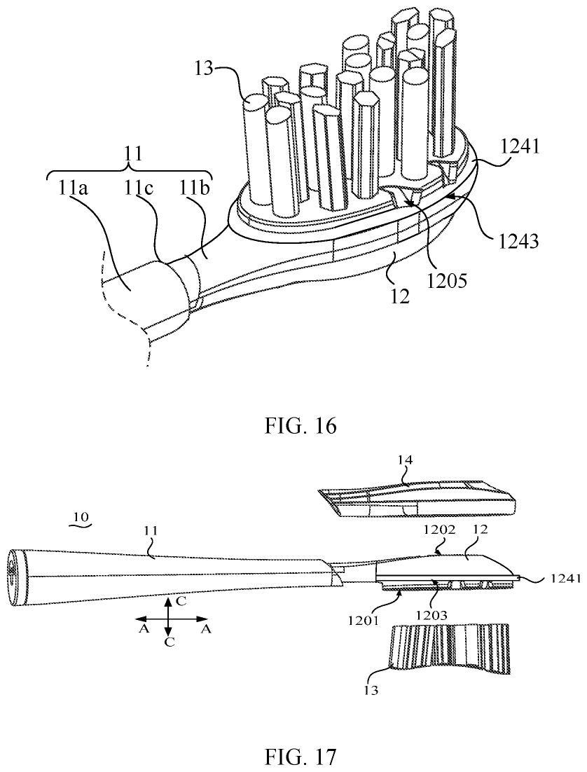

As shown in FIGS. 14-15, in another embodiment of the brush head 10, the brush head 10 comprises a brush rod 11, a brush plate 12, bristles 13, and a soft elastic piece 14. The brush plate 12 in the embodiment may comprise a filling groove 12a or may not comprise the filling groove 12a. As shown in FIG. 16 and FIG. 17, the brush plate 12 is connected to one end of the brush rod 11 in a length direction AA. The brush plate 12 defines a width direction BB and a thickness direction CC, and the width direction BB, the thickness direction CC, and the length direction AA are perpendicular to each other.

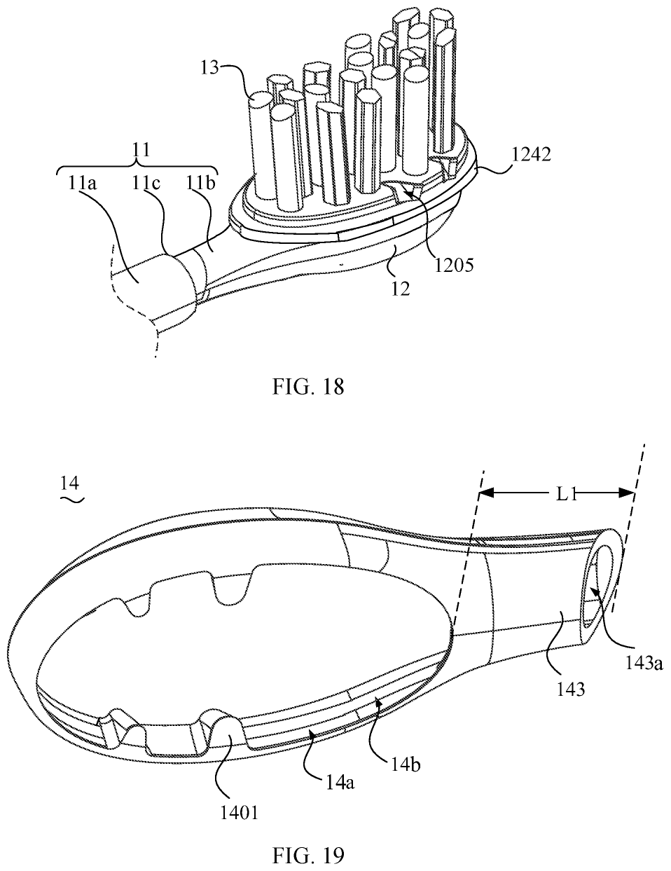

As shown in FIGS. 17-18, the brush plate 12 comprises a bristle fixing surface 1201 and an outer back surface 1202. The bristle fixing surface 1201 is opposite to the outer back surface 1202 along the thickness direction CC. The outer back surface 1202 of the brush plate 12 is a surface of the back plate 122 opposite to the bristle fixing surface 1201 of the bristle fixing plate. The bristles 13 are disposed on the bristle fixing surface 1201 of the brush plate 12. The outer back surface 1202 of the brush plate 12 is opposite to the bristles 13. Referring to the embodiments mentioned above, an outer wall surface of the back plate is disposed between the bristle fixing surface 1201 of the brush plate 12 and the outer back surface 1202 of the brush plate 12, and a peripheral side surface of the bristle fixing plate and the outer wall surface of the back plate form an outer peripheral surface 1203 of the brush plate 12. The outer peripheral surface 1203 of the brush plate 12 extends from the bristle fixing surface 1201 to the outer back surface 1202 of the brush plate 12 along the thickness direction CC.

A bonding portion 124 is disposed on the outer peripheral surface 1203 of the brush plate. The bonding portion 124 is configured to connect and combine with the soft elastic piece 14. As shown in FIG. 17, the bonding portion 124 comprises a first step structure 1241, or as shown in FIG. 18, the bonding portion 124 comprises a ridge structure 1242, or, the bonding portion 124 comprises the first step structure 1241 and the ridge structure 1242. Comparing FIGS. 17 with FIG. 18, it is noted that a difference between the first step structure 1241 and the ridge structure 1242 is that the first step structure 1241 protrudes relative to one side of the outer peripheral surface 1203 of the brush plate 12, and the ridge structure 1242 protrudes relative to two sides of the outer peripheral surface 1203 of the brush plate 12. It should be noted that the bonding portion 124 is a protrusion structure on the outer peripheral surface 1203 of the brush plate 12, so that the bonding portion 124 is embedded into the soft elastic piece 14. Further, in addition to the first step structure 1241 and the ridge structure 1242, other similar structures may also be used as the bonding portion 124 of the embodiment.

Furthermore, ad shown in FIGS. 15-18, the brush plate 12 is formed by injection molding. First cross sections of the brush plate 12 are perpendicular to the thickness direction CC of the brush plate 12. The first cross sections are unchanged or gradually reduced from the bonding portion 124 to the bristle fixing surface 1201 of the bristle fixing plate 121 along the thickness direction CC. Second cross sections of the brush plate 12 are perpendicular to the thickness direction CC of the brush plate 12. The second cross sections are unchanged or gradually reduced along the thickness direction CC from the bonding portion 124 to the outer back surface 1202 of the brush plate 12.

That is, by taking the bonding portion 124 as a boundary, a portion of the brush plate 12 between the bonding portion 124 and the bristle fixing surface 1201 has the first cross sections, dimensions of the first cross sections are unchanged or gradually reduced from the bonding portion 124 to the bristles 13. Similarly, a portion of the brush plate 12 between the bonding portion 124 and the outer back surface 1202 has the second cross sections, and dimensions of the second cross sections are unchanged or gradually reduced from the bonding portion 124 to the thickness direction away from the bristles 13.

In this way, in the injection molding process of the brush plate 12, a certain plane where the bonding portion 124 is located is taken as a molding surface (the molding surface is perpendicular to the thickness direction CC), a first mold (such as an upper mold) and a second mold (such as a lower mold) are closed at the molding surface to form a molding cavity, an injection liquid is injected into the molding cavity, and after the injection liquid solidifies, the brush plate 12 is formed. Afterwards, demolding is performed. Since the dimensions of the first cross sections are unchanged or gradually reduced, the first mold is smoothly removed. Similarly, since the dimensions of the second cross sections are unchanged or gradually reduced, the second mold is smoothly removed. Therefore, the brush plate 12 is taken out after removing the first mold and the second mold.

The bristles 13 are disposed on the brush plate 12 and extend from the bristle fixing surface 1201 of the brush plate. That is, the roots of the bristles 13 are embedded in the brush plate 12 and extend out of the brush plate 12 from the bristle fixing surface 1201 of the brush plate 12. The bristles 13 are disposed on the brush plate 12 through a copper bristle fixing process or a copper-free bristle fixing process.

The soft elastic piece 14 is injection molded on an outer side of the brush plate 12 and connected to the brush plate 12. Specifically, after the brush plate 12 is formed through the injection molding process, the soft elastic piece 14 is molded on the outer side of the brush plate 12 through a secondary injection molding process or a two-color injection molding process, so as to realize connection between the soft elastic piece 14 and the brush plate 12.

After the soft elastic piece 14 and the brush plate 12 are integrally injection molded, the soft elastic piece 14 is covered on the outer back surface 1202 and the outer peripheral surface 1203 of the brush plate 12. In this way, a connection area between the soft elastic piece and the brush plate 12 is increased, and connection stability between the soft elastic piece 14 and the brush plate 12 is enhanced. Specifically, the outer back surface 1202 of the brush plate 12 prevents the soft elastic piece 14 from peeling off in the direction close to the bristles 13, and the outer peripheral surface 1203 of the brush plate 12 prevents the soft elastic piece 14 from moving laterally (a transverse direction is any direction perpendicular to the thickness direction CC) to peel off from the brush plate 12.

Since the soft elastic piece 14 covers on the outer peripheral surface 1203 of the brush plate 12 and the bonding portion 124 is disposed on the outer peripheral surface 1203 of the brush plate 12, the soft elastic piece 14 also covers on the bonding portion 124. Specifically, as shown in FIG. 19, the soft elastic piece 14 comprises an inner peripheral surface 14a opposite to the outer peripheral surface 1203 of the brush plate 12. The inner peripheral surface 14a of the soft elastic piece 14 defines a fitting groove 14b due to an existence of the bonding portion 124 during the injection molding process of the soft elastic piece 14. The bonding portion 124 is embedded in the fitting groove 14b, so that the bonding portion 124 and the fitting groove 14b are matched and connected. In this way, not only is the soft elastic piece 14 prevented from being peeled off from the brush plate 12 in the thickness direction CC close to or away from the bristles 13, but also the soft elastic piece 14 is prevented from moving laterally away from the brush plate 12, which further enhances the connection stability between the soft elastic piece 14 and the brush plate 12. Even if the brush head 10 is in a humid environment for a long time, it is ensured that the soft elastic piece 14 does not peel off from the brush plate 12.

To sum up, in the embodiment, the soft elastic piece 14 is injection molded on the outer side of the brush plate 12, and a close connection between the soft elastic piece 14 and the brush plate 12 is realized during the injection molding process. Furthermore, the soft elastic piece 14 is covered on the outer back surface 1202 and the outer peripheral surface 1203 of the brush plate 12, which increases the connection area between the soft elastic piece 14 and the brush plate 12, and enhances the connection stability between the soft elastic piece 14 and the brush plate 12. Specifically, the outer back surface 1202 of the brush plate 12 prevents the soft elastic piece 14 from peeling off in the direction close to the bristles 13, and the outer peripheral surface 1203 of the brush plate 12 prevents the soft elastic piece 14 from moving laterally and peeling off from the brush plate 12.

Furthermore, the bonding portion 124 is disposed on the outer peripheral surface 1203 of the brush plate 12, the bonding portion 124 comprises at least one of the first step structure 1241 and the ridge structure 1242, and the soft elastic piece 14 is covered on the bonding portion 124. In this way, not only is the soft elastic piece 14 prevented from being peeled off from the brush plate 12 in the thickness direction CC close to or away from the bristles 13, but also the soft elastic piece 14 is prevented from moving laterally away from the brush plate 12. Further, the connection stability between the soft elastic piece 14 and the brush plate 12 is enhanced. Even if the brush head 10 is in the humid environment for a long time, it can be ensured that the soft elastic piece 14 does not peel off from the brush plate 12.

In addition, the first cross sections of the brush plate 12 are perpendicular to the thickness direction CC of the brush plate 12, and the first cross sections are unchanged or gradually reduced from the bonding portion 124 to the bristle fixing surface 1201 of the brush plate 12 along the thickness direction CC. The second cross sections of the brush plate 12 are perpendicular to the thickness direction CC of the brush plate 12, and the second cross sections are unchanged or gradually reduced from the bonding portion 124 to the outer back surface of the brush plate 12 along the thickness direction CC. In this way, in the injection molding process of the brush plate 12, the certain plane where the bonding portion 124 is located is taken as the molding surface, the first mold (such as the upper mold) and the second mold (such as the lower mold) are closed at the molding surface to form the molding cavity. The injection liquid is injected into the molding cavity, and after the injection liquid solidifies, the brush plate 12 is formed. Afterwards, demolding is performed. Since the dimensions of the first cross sections are unchanged or gradually reduced, the first mold is smoothly removed. Similarly, since the dimensions of the second cross sections are unchanged or gradually reduced, the second mold is smoothly removed. Therefore, the brush plate 12 is taken out after removing the first mold and the second mold.

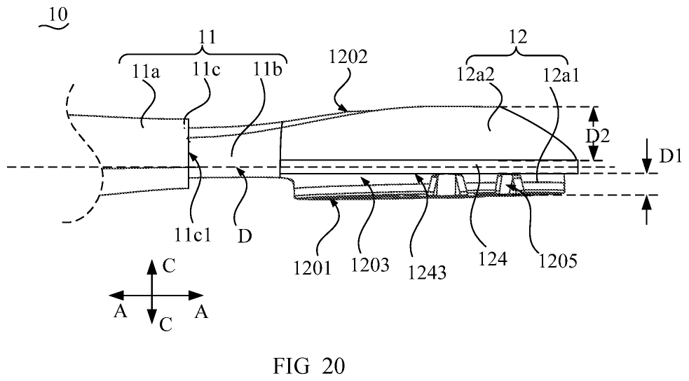

As shown in FIG. 20, in some embodiments, the brush plate 12 is divided into a first section 12a1 and a second section 12a2 along the thickness direction CC by the bonding portion 124. The first section 12a1 comprises the first cross sections, the second section 12a2 comprises the second cross sections, and each of the first cross sections is smaller than each of the second cross sections, so as to form the first step structure 1241 on the outer peripheral surface 1203 of the brush plate 12. The first step structure 1241 comprises a first step surface 1243, and the first step surface 1243 thereof is disposed toward the bristle fixing surface 1201 of the brush plate 12. In this way, when the soft elastic piece 14 moves backwards (i.e., moving away from the bristles 13), the soft elastic piece 14 is snapped on the first step surface 1243 of the first step structure 1241, and the soft elastic piece 14 is fastened on the brush plate 12, so that the soft elastic piece 14 is prevented from being peeled off from the brush plate 12 in the thickness direction away from the bristles 13.

As shown in FIGS. 19-20, in some embodiments, the bonding portion 124 is disposed around the outer peripheral surface 1203 of the brush plate 12. In this way, the soft elastic piece 14 is snapped on the bonding portion 124, which has a better connection effect and makes the soft elastic piece 14 less likely to peel off from the brush plate 12.

In some embodiments, the first section 12a1 comprises the bristle fixing surface 1201, the second section 12a2 comprises the outer back surface 1202, and the slots 1205 are defined on the outer peripheral surface 1203 of the brush plate 12.

In some embodiments, the slots 1205 penetrate from the bristle fixing surface 1201 to the outer back surface 1202 of the brush plate 12. Due to an existence of the slots 1205, during the injection molding process of the soft elastic piece 14, the injection liquid fills the slots 1205 and form protrusions 1401. The protrusions 1401 are respectively embedded in the slots 1205 and connected to slot walls of the slots 1205. In this way, the connection area between the soft elastic piece 14 and the brush plate 12 is increased, and the connection stability between the soft elastic piece 14 and the brush plate 12 is enhanced.

It should be noted that when the slots 1205 penetrate from the bristle fixing surface 1201 to the outer back surface 1202 of the brush plate 12, it should not affect the demolding of the first mold and the second mold. Therefore, the cross sections of the slots 1205 perpendicular to the thickness direction CC are unchanged. Alternatively, the molding surface of the first mold and the second mold corresponds to a minimum cross section of each of the slots. That is, from the minimum cross section of each of the slots to the bristle fixing surface 1201 of the brush plate 12, the cross sections of each of the slots 1205 gradually increase. In this way, it is convenient for the first mold and the second mold to move away from each other for demolding without being hindered by the slots 1205.

In another embodiment, the slots 1205 are defined on the first section 12a1 and penetrate through the bristle fixing surface 1201 of the brush plate 12 along the thickness direction CC. For example, the slots 1205 defined on the first section 12a1 penetrate from the bonding portion 124 to the bristle fixing surface 1201 of the brush plate 12 along the thickness direction CC. From the bonding portion 124 to the bristle fixing surface 1201 of the brush plate 12 along the thickness direction CC, the cross sections of each of the slots 1205 gradually increase. That is, the slots 1205 are only defined on the first section 12a1, and the slots 1205 are blind slots (i.e., the slots do not penetrate through the outer back surface 1202 of the brush plate 12). It is understood that in the injection molding process of the brush plate 12, in order to form the slots 1205, the first mold needs to have convex portions corresponding to the slots 1205. Therefore, the cross sections of each of the slots 1205 gradually increases in the thickness direction close to the bristle fixing surface 1201 of the brush plate 12. In this way, the convex portions in the first mold are easily separated from the slots 1205 during demolding.

Due to the existence of the slots 1205, during the injection molding process of the soft elastic piece 14, the injection liquid fills the slots 1205 and form the protrusions 1401. The protrusions 1401 are respectively embedded in the slots 1205 and connected to the slot walls of the slots 1205. Since the cross sections of the slots 1205 gradually increase in the thickness direction close to the bristle fixing surface 1201 of the brush plate 12, the cross sections of the protrusions 1401 also gradually increase in the thickness direction close to the bristle fixing surface 1201 of the brush plate 12. In this way, when the soft elastic piece 14 moves away from the bristles 13, the protrusions 1401 are respectively engaged in the slots 1205, which further prevent the soft elastic piece 14 from peeling off from the brush plate 12. It is understood that the slots 1205 may not penetrate through the bristle fixing surface 1201 of the brush plate 12 from the bonding portion 124 along the thickness direction CC, but may penetrate the bristle fixing surface 1201 of the brush plate 12 from any position between the bonding portion 124 and the bristle fixing surface 1201 of the brush plate 12 along the thickness direction CC, which also realizes above effects.

As shown in FIG. 20, in some embodiments, the brush rod 11 and the brush plate 12 are integrally formed by injection molding. The brush rod 11 has a middle cross section D perpendicular to the thickness direction CC, the bonding portion 124 comprises a maximum cross section perpendicular to the thickness direction CC. The maximum cross section of the bonding portion 124 overlaps the middle cross section D of the brush rod 11.

The brush rod 11 is roughly cylindrical. The brush rod 11 has a maximum cross section which is the middle cross section D. Therefore, the maximum cross section of the brush rod 11 overlaps the maximum cross section of the brush plate 12. The maximum cross section of the brush rod 11 and the maximum cross section of the brush plate 12 are served as a molding surface of the brush rod 11 and the brush plate 12. In this way, the brush rod 11 and the brush plate 12 are integrally injection molded, and the demolding of the first mold and the second mold is facilitated.

As shown in FIG. 20, in some embodiments, the first section 12a1 has a first thickness D1 along the thickness direction CC, the second section 12a2 has a second thickness D2 along the thickness direction CC, and the first thickness D1 is less than the second thickness D2. Therefore, the bonding portion 124 is made closer to the bristle fixing surface 1201 relative to the outer back surface 1202 of the brush plate 12, the soft elastic piece 14 covers more areas of the second section 12a2, the connection area of the soft elastic piece 14 with the second section 12a2 is larger, and the second section 12a2 more effectively prevents the soft elastic piece 14 from peeling off from the brush plate 12 in the thickness direction away from the bristles 13.

As shown in FIGS. 19-20, in some embodiments, the soft elastic piece 14 comprises a sleeving portion 143, and the sleeving portion 143 is annular and is sleeved on the brush rod 11. In this way, the soft elastic piece 14 is prevented from peeling off from the brush rod 11. If the soft elastic piece 14 is unable to peel off from the brush rod 11, it is more difficult for the soft elastic piece 14 to peel off from the brush plate 12. Therefore, the connection stability between the soft elastic piece 14 and the brush plate 12 is indirectly enhanced.

Furthermore, as shown in FIGS. 15 and 19, the sleeving portion 143 defines a sleeving hole 143a for the brush rod 11 to pass through. A diameter of the sleeving hole 143a is less than a width of the brush plate 12 along the width direction BB. Since the brush plate 12 blocks the sleeving portion 143, the sleeving portion 143 is unable to separate from the brush rod 11 along the length direction AA. Therefore, the connection stability between the soft elastic piece 14, the brush plate 12, and the brush rod 11 is further enhanced.

Furthermore, as shown in FIGS. 15 and 19, in some embodiments, the sleeving portion 143 is sleeved on a section of the brush rod 11 close to the brush plate 12 (that is, a second rod section 11b described below), and a length L1 of the sleeving portion 143 along the length direction AA is no more than 20 mm, so that the brush rod 11 is partially exposed on the soft elastic piece 14. That is, the sleeving portion 143 does not completely wrap the brush rod 11, and the section of the brush rod 11 away from the brush plate 12 is not wrapped by the sleeving portion 143. Since friction between the soft elastic piece 14 and oral mucosa of the user is relatively large, if the sleeving portion 143 completely wraps the brush rod 11, after the brush head 10 is put into the oral cavity, except for the bristle fixing surface 1201 of the brush plate 12 where the bristles 13 are located, all other areas of the brush head 10 are in contact with the oral cavity through the soft elastic piece 14, which not only makes it difficult for the brush head 10 to move in the oral cavity, but also causes discomfort to the user. In the embodiment, the section of the brush rod 11 away from the brush plate 12 is not sleeved by the sleeving portion 143, which directly contacts the oral mucosa of the user, facilitates the movement of the brush head 10 in the oral cavity, and improves the comfort of the user during brushing.

As shown in FIG. 20, in some embodiments, the brush rod 11 comprises a first rod section 11a and the second rod section 11b. The first rod section 11a is connected to the brush plate 12 through the second rod section 11b. Cross sections of the first rod section 11a a perpendicular to the length direction AA are greater than cross sections of the second rod section 11b perpendicular to the length direction AA (i.e., a diameter of the first rod section 11a is greater than a diameter of the second rod section 11b), so that a second step structure 11c is defined between the first rod section 11a and the second rod section 11b. The second step structure 11c comprises a second step surface 11c1 disposed towards the brush plate 12. The sleeving portion 143 is sleeved on the second rod section 11b and abuts against the second step surface 11c1 of the second step structure 11c. In this way, after the sleeving portion 143 wraps the second rod section 11b, the sleeving portion 143 is flush or nearly flush with a surface of the first rod section 11a, and an edge of the sleeving portion 143 close to the first rod section 11a does not protrude too much relative to the surface of the first rod section 11a, avoiding a problem that the edge of the sleeving portion 143 is tilted and sleeved on the first rod section 11a due to force (for example, the soft elastic piece 14 is subjected to oral force when the user brushes his or her teeth).

In some embodiments, based on the embodiment in which the brush rod 11 and the brush plate 12 are integrally formed, a maximum cross section, perpendicular to the thickness direction CC, of the second step structure 11c overlaps the middle cross section D. Namely, bounding by the middle cross section D, the second step structure 11c extends toward two sides away from the middle cross section D, and there is no snapping structure or obstacle that hinders the demolding of the first mold and the second mold, ensuring that the first mold and the second mold is demolded smoothly.

In some embodiments, based on the embodiment in which the soft elastic piece 14 and the brush plate 12 are integrally formed, bristle fixing holes (not shown in the FIGS. 19-20) are defined on the bristle fixing surface 121a of the brush plate 12, and the bristle fixing holes are blind holes. The brush head 10 also comprises copper sheets (not shown in the drawings), and the roots of the bristles 13 are installed in the bristle fixing holes through the copper sheets. Namely, the bristle fixing holes do not penetrate through the brush plate 12 along the thickness direction CC, and the bristles 13 are fixed on the brush plate 12 through a copper bristle fixing process. In this way, after the brush rod 11 and the brush plate 12 are integrally formed, the soft elastic piece 14 is directly disposed on the outer side of the brush plate 12 through injection molding, and then the roots of the bristles 13 are fixed in the bristle fixing holes through the copper sheets. A bristle fixing process thereof is reliable and simple.

If a copper-free bristle fixing process is adopted, when the brush plate 12 is formed, through holes needs to be formed together. When the bristles are fixed, the bristles 13 need to pass through the through holes and ironed on the outer back surface 1202 of the brush plate 12. Specifically, one end of each of the bristles 13 is welded to the brush plate 12, which is complicate and has high cost.

In some embodiments, the soft elastic piece 14 covering the outer peripheral surface 1203 of the brush plate 12 does not exceed the bristle fixing surface 1201 of the brush plate 12. In this way, during the injection molding process of the soft elastic piece 14, the injecting liquid does not flow to the bristle fixing surface 1201 of the brush plate 12, which prevents the bristles 13 from bonding to each other if the injecting liquid flows to the bristle fixing surface 1201, thus preventing a reduction in the elasticity and freedom of the bristles 13.

Further, in the thickness direction CC, a distance between an edge of the soft elastic piece 14 at the outer peripheral surface 1203 of the brush plate 12 and the bonding portion 124 is no more than 3 mm. In this way, the distance between the edge of the soft elastic piece 14 at the outer peripheral surface 1203 of the brush plate 12 and the bonding portion 124 is relatively small, and the bonding portion 124 has a stronger binding force on the edge of the soft elastic piece 14. If the distance between the edge of the soft elastic piece 14 at the outer peripheral surface 1203 of the brush plate 12 and the bonding portion 124 is greater than 3 mm, it indicates that the distance between the edge of the soft elastic piece 14 at the outer peripheral surface 1203 of the brush plate 12 and the bonding portion 124 is too large, and the bonding portion 124 has small binding force on the edge of the soft elastic piece 14, which increases a risk that the soft elastic piece 14 peels off from the brush plate 12.

The above content introduces the structural form of the brush head 10 that protect the oral cavity during use and has a strong structure from two aspects. In addition, the present disclosure further improves the structure of the bristles to improve the oral cleaning effect.

### Embodiment 4

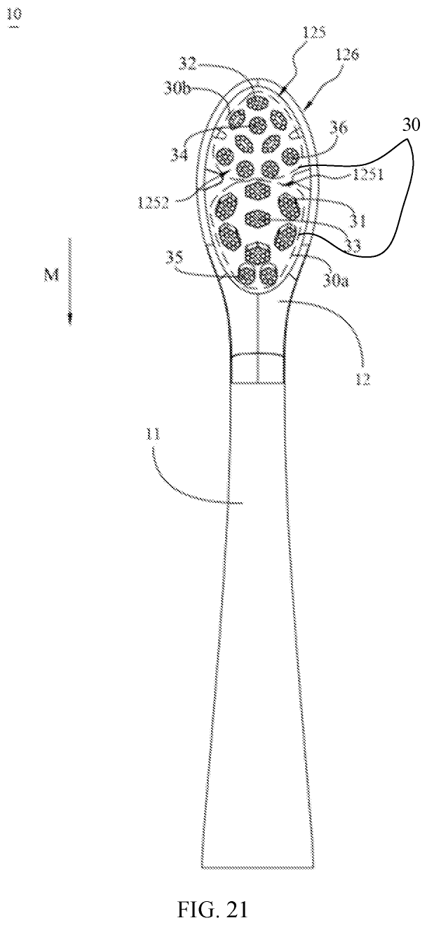

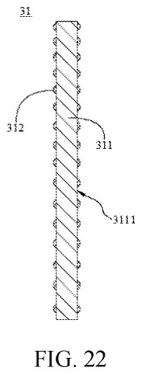

In order to improve the cleaning ability of the brush head 10, as shown in FIGS. 21-22, another embodiment of the present disclosure provides a brush head 10. The brush head 10 comprises a brush rod 11, a brush plate 12, and bristles 30. The brush rod 11 extends along a length direction M. The brush plate 12 is connected to one end of the brush rod 11 in the length direction M. The brush plate 12 has a bristle fixing surface 125 and the bristles 30. A first end of each of the bristles 30 is connected to the brush plate 12, and a second end of each of the bristles 30 extends in a direction away from the bristle fixing surface 125 of the brush plate 12. The bristles 13 comprise friction increasing clusters 31. A surface roughness of the friction increasing clusters 31 is greater than a surface roughness of other bristles 30, so that a friction coefficient between the friction increasing clusters 31 and an object to be brushed (i.e., the teeth) is greater than a friction coefficient between the other bristles 30 except the friction increasing clusters 31 and the object to be brushed.

The brush rod 11 is a component of the brush head 10 that is configured to support the brush plate 12. A designer can reasonably select preparation material of the brush rod 11 according to actual needs, which is not specifically limited thereto.

The brush rod 11 extends along the length direction M. For instance, the brush rod 11 is a straight rod, in which a central axis thereof coincides with the length direction M. Alternatively, the brush rod 11 is a curved rod, in which a line between two endpoints, away from each other, of the brush rods 11 coincides with the length direction M.

The brush plate 12 is a component of the brush head 10 that is configured to carry the bristles 30. A specific shape of the brush plate 12 is not limited therein. The designer can reasonably design the shape of the brush plate 12 according to actual needs. For instance, a shape of the brush plate 12 may be, but is not limited to, rectangular, circular, oval, etc. Of course, the specific preparation material of the brush plate 12 is not limited thereto, and the designer can also reasonably select the preparation material of the brush plate 12 according to actual needs.

The brush plate 12 is connected to one end of the brush rod 11 in the length direction M. That is, the brush plate 12 is connected to the brush rod 11. Further, the brush plate 12 extends along a direction parallel to the length direction M and away from the brush rod 11.

The brush plate 12 has a bristle fixing surface 125. The bristle fixing surface 125 of the brush plate 12 is a flat surface, a curved surface, or a combination of the flat surface and the curved surface.

The bristles 30 are components of the brush head 10 that are configured to clean the objects to be brushed. Specific material for the bristles 30 is not limited thereto. The designer can reasonably select the material for the bristles 30 according to actual needs. For instance, the material for preparing the bristles 30 may comprise, but is not limited to, one or more of polyamide nylon (PA) and polyethylene terephthalate (PBT).

The first end of each of the bristles 30 is connected to the brush plate 12, and the second end of each of the bristles 30 extends in the direction away from the bristle fixing surface 125 of the brush plate 12.

In some embodiments, the bristles 30 comprise the friction increasing clusters 31, and the friction increasing clusters 31 comprise different brush wires 311, or the friction increasing clusters 31 comprise brush wires 311 having the same structures. For instance, the friction increasing clusters 31 comprise different brush wires of different materials, or friction increasing clusters 31 comprise mixing brush wires with different single surface roughness of the same material. An included angle between an extension direction of at least part of the friction increasing clusters 31 and the bristle fixing surface 125 of the brush plate 12 is an acute angle or an obtuse angle. That is, the at least part of the friction increasing clusters 31 is inclined relative to the bristle fixing surface 125 of the brush plate 12, so that a free end 3131 of the at least part of the friction increasing clusters 31 (will be described in details below) is inclined towards the brush rod 11 relative to roots of the friction increasing clusters 31, making the friction increasing clusters 31 expand outwards and increasing a contact area between the friction increasing clusters 31 and the teeth of the user, which improves overall cleaning capability of the brush head 10. For instance, the included angle between the extension direction of the at least part of the friction increasing clusters 31 and the bristle fixing surface 125 of the brush plate 12 is 85 degrees or 95 degrees. Alternatively, the included angle between the extension direction of the at least part of the friction increasing clusters 31 and the bristle fixing surface 125 of the brush plate 12 is a right angle. That is, the included angle between the at least part of the friction increasing clusters 31 and the bristle fixing surface 125 of the brush plate is 90 degrees. It should be noted that when at least part of the bristle fixing surface 125 of the brush plate 12 is the curved surface, it is understood that the curved surface is formed by connecting a plurality of small flat surfaces together, and each of the brush wires in the at least part of the friction increasing clusters 31 is inclined relative to a corresponding small flat surface in the curved surface, so that the at least part of the friction increasing clusters 31 is inclined relative to the bristle fixing surface 125 of the brush plate 12.

As shown in FIG. 22, in some embodiments, the friction increasing clusters 31 comprise brush wires 311 and friction structures 312. One or more of the friction structures 312 are disposed on an outer surface 3111 of each of the brush wires 311. Each of the friction structures 312 protrudes from the outer surface 3111 of a corresponding brush wire 311. Each of the friction structures 312 is a bulge disposed on the outer surface 3111 of the corresponding brush wire 311. A specific shape of each of the friction structures 312 is not limited thereto. For example, each of the friction structures 312 is a hemispherical bulge or an annular bulge surrounding the corresponding brush wire 311 along an axial direction of the corresponding brush wire 311. By providing the one or more of friction structures 312 on the outer surface 3111 of each of the brush wires 311, a roughness of the outer surface 3111 of the each of the brush wires 311 is increased, thereby increasing the friction coefficient between the friction increasing clusters 31 and the teeth of the user.

The friction coefficient between the friction increasing clusters 31 and the object to be brushed is greater than the friction coefficient between the other bristles 30 except the friction increasing clusters 31 and the object to be brushed.

Based on the brush head 10 in the embodiments of the present disclosure, by providing the friction increasing clusters 31 and defining the friction coefficient between the friction increasing clusters 31 and the object to be brushed being greater than the friction coefficient between the other bristles 30 and the object to be brushed, when the user brushes his or her teeth during the brushing process, the friction force between the friction increasing clusters 31 and the teeth of the user is relatively large, so that the teeth of the user are sufficiently brushed by the bristles 30, thereby improving the overall cleaning capability of the brush head 10.

It is understood that application scenarios of the brush head 10 are different according to different specific expression forms of the object to be brushed. For example, when the object to be brushed is tableware, the brush head 10 is a brush head 10 applied to a dish washing brush; when the object to be brushed is the teeth of the user, the brush head 10 is a brush head 10 applied to a toothbrush; and when the object to be brushed is a toilet, the brush head 10 is a brush head 10 applied to a toilet brush. For convenience of description, the following takes the teeth of the user as the objects to be brushed and the brush head 10 applied to the toothbrush as an example.

As shown in FIG. 22, when the user brushes teeth, due to many factors, such as a holding posture of the toothbrush of the user or a shape of the teeth of the user, bristles 30 close to a front end of the brush head 10 (one end of the brush plate 12 away from the brush rod 11) contact the teeth of the user first, and the bristles 30 close to a back end of the brush head 10 (one end of the brush plate 12 close to the brush rod 11) contact the teeth of the user later. Moreover, during the brushing process, due to a limitation of a brushing posture, the bristles 30 close to the back end of the brush head 10 are lifted relative to the teeth of the user. As a result, the bristles 30 close to the back end of the brush head 10 are not effectively in contact with the teeth of the user, and the friction force between the bristles 30 close to the back end of the brush head 10 and the teeth of the user is small, resulting in a poor cleaning capacity of the brush head 10. In order to improve the overall cleaning capacity of the brush head 10, in some embodiments, the bristle fixing surface 125 of the brush plate 12 comprises a first area 1251 and a second area 1252. The first area 1251 and the second area 1252 are located in the length direction M. The first area 1251 is closer to the brush rod 11 than the second area 1252. The bristles 30 comprise a first bristle group 30a disposed in the first area 1251 and a second bristle group 30b disposed in the second area 1252. The first bristle group 30a at least comprises the friction increasing clusters 31. The first bristle group 30a at least comprises the friction increasing clusters 31, which increase the friction coefficient between the first bristle group 30a located at the back end of the brush head 10 and the teeth of the user. Therefore, the friction force between the first bristle group 30a and the teeth of the user is increased, which improves the overall cleaning capacity of the brush head 10 when the user brushed teeth.

### Embodiment 5

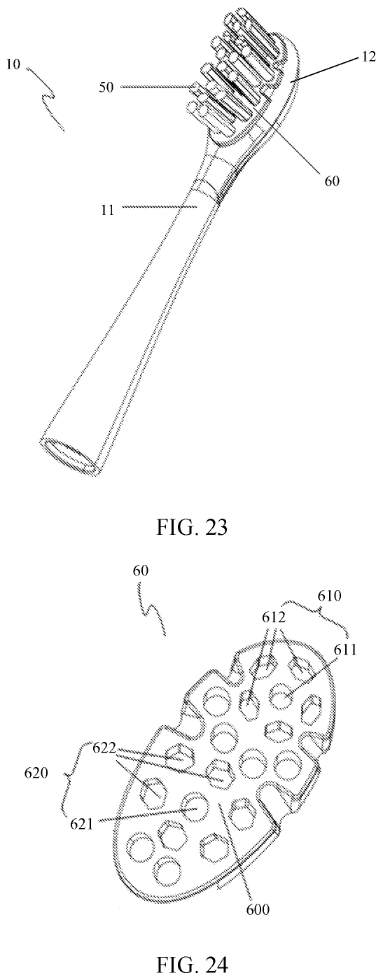

As shown in FIGS. 23-25, in another embodiment, the brush head 10 of the present disclosure comprises a brush rod 11, a brush plate 12, and bristles 50. The brush plate 12 comprises a back plate (not labeled) and a bristle fixing plate 60. In the embodiment, a recess is defined on the back plate of the brush plate 12, and the bristle fixing plate 60 is installed in the recess through bonding, or the bristle fixing plate 60 and the back plate are integrally formed and the bristle fixing plate 60 is fixedly installed in the recess.

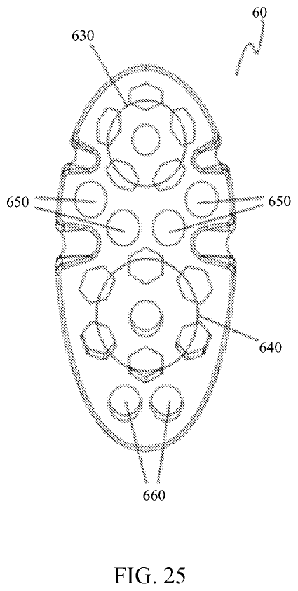

As shown in FIGS. 23 and 25, the bristle fixing plate 60 defines a length direction and a width direction. The width direction is perpendicular to the length direction. Bristle fixing holes configured to fix the bristles 50 are defined on a bristle fixing surface 600 of the bristle fixing plate 60. The bristles 50 are fixed in the bristle fixing holes, so that the bristle fixing plate 60 with the bristles 50 fixed thereon consists a part of the brush head 10. During the brushing process, the bristles 50 fixed in the bristle fixing holes are repeatedly rubbed against the teeth to clean the teeth of the user. Therefore, different arrangements of the bristles 50 on the bristle fixing plate 60 lead to different tooth-brushing effects. Although conventional bristles are neatly disposed, there are gaps between rows or columns of bristle clusters formed by the conventional bristles fixed in bristle fixing holes of a conventional brush head. As a result, some areas of the teeth are not in contact with the conventional bristles, thus affecting a brushing effect.

In the embodiment, the bristle fixing surface 600 of the bristle fixing plate 60 comprises a first bristle fixing area 610 and a second bristle fixing area 620. The first bristle fixing area 610 and the second bristle fixing area 620 are disposed along a length direction of the bristle fixing plate 60. The first bristle fixing area 610 defines at least one first central bristle fixing hole 611 and first auxiliary bristle fixing holes 612 disposed at intervals around the at least one first central bristle fixing hole 611. The shape (e.g., circular), number, and arrangement of the at least one first central bristle fixing hole 611 can be set as needed, which are not limited thereto. A shape of each of the first auxiliary bristle fixing holes 612, the number of the first auxiliary bristle fixing holes, arrangements of the first auxiliary bristle fixing holes around the at least one first central bristle fixing hole 611 can also be set as needed. The second bristle fixing area 620 defines second auxiliary bristle fixing holes 622 disposed at intervals.

Furthermore, the first bristle fixing hole area 610 is close to a free end of the bristle fixing surface 600 of the bristle fixing plate 60. The free end of the bristle fixing surface 600 of the bristle fixing plate 60 is opposite to the one end of the bristle fixing plate 60 connected to the brush rod. A width of the bristle fixing surface 600 of the bristle fixing plate 60 starts from the free end thereof and gradually increases along the length direction of the bristle fixing plate 60, so the width of the bristle fixing surface 600 of the bristle fixing plate 60 increases accordingly. Based on this, a width of the second bristle fixing hole area 620 is generally greater than a width of the first bristle fixing hole area 610, so there is a larger area for arrangements of the second auxiliary bristle fixing holes 622. Namely, a larger size of each of the second auxiliary bristle fixing holes 622 or a greater number of the second auxiliary bristle fixing holes 622 are defined in the second bristle fixing hole area 620, and the second auxiliary bristle fixing holes 622 defined in the second bristle fixing hole area 620 are allowed to have more arrangements. Projections of the bristle fixing holes on the width direction along the length direction of the bristle fixing surface 600 of the bristle fixing plate 60 are defined as first projections. At least part of projections of the second auxiliary bristle fixing holes 622 are located in projection intervals of adjacent first auxiliary bristle fixing holes 612, and/or at least part of projections of the first auxiliary bristle fixing holes 612 are located in projection intervals of adjacent second auxiliary bristle fixing holes 622; so that the first projections of the bristle fixing holes are connected together to form a continuous line segment.

Specifically, when there is a gap between each two adjacent first auxiliary bristle fixing holes 612, the projection intervals are defined between the first projections of the first auxiliary bristle fixing holes 612 that fall in the width direction of the bristle fixing surface 600 of the bristle fixing plate 60 along the length direction of the bristle fixing surface 600 thereof. When the user brushes the teeth, the toothbrush is controlled to move repeatedly along the length direction of the bristle fixing plate 60, and an existence of the projection intervals between the first projections of the first auxiliary bristle fixing holes 612 causes areas of the teeth corresponding to the projection intervals between the first projections of the first auxiliary bristle fixing holes 612 being not in contact with the bristles. However, by arrangements of the second auxiliary bristle fixing holes 622, the first projections of the at least part of the second auxiliary bristle fixing holes 622 falling on the width direction of the bristle fixing plate 60 along the length direction of the bristle fixing surface 600 respectively fill the projection intervals between the first projections of the first auxiliary bristle fixing holes 612. Therefore, first projections of the bristles (i.e., the bristles 50 fixed in all of the bristle fixing holes on the bristle fixing surface 600 of the bristle fixing plate 60) falling on the width direction of the bristle fixing plate 60 along the length direction of the bristle fixing surface 600 of the bristle fixing plate 60 are continuous with no intervals. In this way, when the toothbrush is repeatedly moved along the length direction of the bristle fixing surface 600 to brush the teeth, the first projections of the bristles in the length direction are continuous. Therefore, the teeth are completely in contact with the bristles. Similarly, the first projections of the first auxiliary bristle fixing holes 121 also fill the projection intervals between the first projections of the second auxiliary bristle fixing holes 622 falling on the width direction of the bristle fixing surface 600 of the bristle fixing plate 60 along the length direction of the bristle fixing surface 600 of the bristle fixing plate 60 through the arrangements thereof

In some embodiments, the second bristle fixing hole area 620 comprises at least one second central bristle fixing hole 621 and the second auxiliary bristle fixing holes 622 disposed around the at least one second central bristle fixing hole 621. The second auxiliary bristle fixing holes 622 are disposed at intervals. At least part of one or more of the first auxiliary bristle fixing holes 612 is located in the projection interval of projections of each two adjacent second auxiliary bristle fixing holes 622. The shape, number, and arrangement of the at least one second central bristle fixing hole 621 can be set as needed, which are not limited thereto. A shape of each of the second auxiliary bristle fixing holes 622, the number of the second auxiliary bristle fixing holes 622, the arrangements of the second auxiliary bristle fixing holes 622 around the at least one second central bristle fixing hole 621 can also be set as needed.

Furthermore, a density of the bristle fixing holes of the first bristle fixing area 610 is set to be different with a density of the bristle fixing holes in of the second bristle fixing area 620 as needed.

The density of the bristle fixing holes refers to a proportion of the bristle fixing holes in a certain area on the bristle fixing surface 600 of the bristle fixing plate 60, and is affected by shapes, sizes, number and arrangements of the bristle fixing holes. Therefore, by setting the arrangements of the bristle fixing holes in the first bristle fixing hole area 610 and the bristle fixing holes in the second bristle fixing hole area 620, the first projections of the bristle fixing holes in the first bristle fixing hole area 610 and the first projections of the bristle fixing holes in the second bristle fixing hole area 620 that fall in the width direction of the bristle fixing surface 600 of the bristle fixing plate 60 along the length direction of the bristle fixing surface 600 of the bristle fixing plate 60 are continuous. For example, each of the bristle fixing holes in the second bristle fixing hole area 620 is disposed between a corresponding projection interval of corresponding first projections of corresponding two adjacent bristle fixing holes in the first bristle fixing hole area 610.

In some embodiments, the density of the bristle fixing holes of the first bristle fixing hole area is greater than the density of the bristle fixing holes of the second bristle fixing hole area, or, a distance between each two adjacent bristle fixing holes in the first bristle fixing hole area is less than a distance between each two adjacent bristle fixing holes in the second bristle fixing hole area. The reason is that when the user inserts the brush head into the oral cavity to brush innermost teeth, due to a limitation of a shape of the oral cavity, a traveling stroke of the brush head is limited. When the brush head moves left and right in the oral cavity, even if the brush head reaches the innermost teeth, the innermost teeth may not completely contact all the bristles, which lead to missed brushing in some areas of the innermost teeth. Therefore, the density of the bristle fixing holes in the first bristle fixing hole area is greater than the density of the bristle fixing holes in the second bristle fixing hole area, or, the distance between each two adjacent bristle fixing holes in the first bristle fixing hole area is less than the distance between each two adjacent bristle fixing holes in the second bristle fixing hole area, so that a cleaning effect of the innermost teeth is effectively improved.

Projections of the bristle fixing holes on the length direction of the bristle fixing surface 600 of the bristle fixing plate 60 along the width direction of the bristle fixing surface 600 of the bristle fixing plate 60 are defined as second projections. A projection of a line segment that connects two bristle fixing holes opposite to each other on outermost sides of the bristle fixing surface 600 of the bristle fixing plate 60 on the length direction along the width direction of the bristle fixing surface 600 of the bristle fixing plate 60 is defined as a third projection. A total length of the second projections is not less than 85% of a length of the third projection.

Specifically, the third projection indicates a distance between the second projections of two furthest bristle fixing holes on the bristle fixing surface 600 of the bristle fixing plate 60. The second projections fall in the length direction of the bristle fixing surface 600 of the bristle fixing plate 60. When there is the gap between each two adjacent bristle fixing holes, there is a projection interval between each two adjacent second projections falling on the length direction of the bristle fixing surface 600 of the bristle fixing plate 60 along the width direction of the bristle fixing surface 600 of the bristle fixing plate 60.

A total length of the second projections of all the bristle fixing holes falling on the length direction of the bristle fixing surface 600 of the bristle fixing plate 60 is at least 85% of the length of the third projection, thereby ensuring that at most 15% of the areas of the teeth are not in contact with the bristles when the toothbrush is repeatedly moved along the width direction of the bristle fixing surface 600 of the bristle fixing plate 60 for brushing, and further ensuring the cleaning effect of the bristles on the teeth. When the total length of the second projections is equal to the length of the third projection, the bristle fixing holes on the bristle fixing surface 600 of the bristle fixing plate 60 are disposed in such a manner that the second projections of all the bristle fixing holes fall in the length direction of the bristle fixing surface 600 of the bristle fixing plate 60 along the width direction of the bristle fixing surface 600 of the bristle fixing plate 60 are continuous with no intervals. In this way, when the toothbrush is repeatedly moved along the width direction of the bristle fixing surface 600 of the bristle fixing plate 60 to brush the teeth, projections of the bristles falling on the length direction along the width direction of the bristle fixing surface 600 of the bristle fixing plate 60 is continuous. Therefore, the teeth are fully in contact with the bristles.

In some embodiments, at least part of the first auxiliary bristle fixing holes 612 is located on a first circumference 630 surrounding the at least one first central bristle fixing hole 611. Centers of the at least part of the first auxiliary bristle fixing holes 612 located on the first circumference 630 are located on the first circumference 630. Shapes and sizes of the first auxiliary bristle fixing holes 612 located on the first circumference 630 are generally the same, which facilitates to disposing the first auxiliary bristle fixing holes 612 located on the first circumference 630 in a circle, and reduces a distance between each two adjacent first auxiliary bristle fixing holes 612 located on the first circumference 630. In addition, at least part of the second auxiliary bristle fixing holes 622 is located on a second circumference 640 surrounding the at least one second central bristle fixing hole 621. Centers of the at least part of the second auxiliary bristle fixing holes 622 located on the second circumference 640 are located on the second circumference 640. Shapes and sizes of the second auxiliary bristle fixing holes 622 located on the second circumference 640 are generally the same, which facilitates to disposing the second auxiliary bristle fixing holes 622 located on the second circumference 640 in a circle, and reduces a distance between each two adjacent second auxiliary bristle fixing holes 622 located on the second circumference 640. The first auxiliary bristle fixing holes 612 located on the first circumference 630 and the second auxiliary bristle fixing holes 622 located on the second circumference 640 are oval, hexagonal, rectangular, etc. Of course, according to actual needs, the shapes or/and sizes of the first auxiliary bristle fixing holes 612 located on the first circumference 630 may be different; and the shapes or/and sizes of the second auxiliary bristle fixing holes 622 located on the second circumference 640 may also be different.

In some embodiments, a hole area of each of the first auxiliary bristle fixing holes 612 located on the first circumference 630 is less than a hole area of each of the second auxiliary bristle fixing holes 622 located on the second circumference 640. Specifically, the hole area of each of the first auxiliary bristle fixing holes 612 located on the first circumference 630 is 50-85% of the hole area of each of the second auxiliary bristle fixing holes 622 located on the second circumference 640.

In some embodiments, an area defined by the first circumference 630 is 45-75% of an area defined by the second circumference 640.

By reasonably setting the shapes, the sizes (or area ratios), and arrangements (or an area ratio of the first circumference to the second circumference) of the first auxiliary bristle fixing holes 612 and the second auxiliary bristle fixing holes 622, a continuous distribution of the first projections of the bristles is realized, which brings a desired cleaning effect of the teeth.

Further, as shown in FIGS. 24 and 25, first reinforcing bristle fixing holes 650 are defined between the first circumference 630 and the second circumference 640. The first reinforcing bristle fixing holes 650 are located in the first bristle fixing hole area 610. The first reinforcing bristle fixing holes 650 are disposed at intervals between the first auxiliary bristle fixing holes 612 and the second auxiliary bristle fixing holes 622 along the width direction. Specifically, the shapes of the first reinforcing bristle fixing holes 650 are different from the shapes of the first auxiliary bristle fixing holes 612 located on the first circumference 630 and the shapes of the second auxiliary bristle fixing holes 622 located on the second circumference 640.

Moreover, the first reinforcing bristle fixing holes 650 are disposed from a minimum distance between the first circumference 630 and the second circumference 640 toward two long sides of the bristle fixing surface 600 of the bristle fixing plate 60. By providing the reinforcing bristle fixing holes 650, the projection intervals between the first projections of the first auxiliary bristle fixing holes 612 on the first circumference 630 and the projection intervals between the first projections of the second auxiliary bristle fixing holes 622 on the second circumference 640 are further filled.

For instance, the first reinforcing bristle fixing holes 650 are disposed in an arc shape. Since an area between the first circumference 630 and the second circumference 640 is relatively wide, more first reinforcing bristle fixing holes 650 may be defined in the area between the first circumference 630 and the second circumference 640 as needed. Furthermore, the shapes of the first reinforcing bristle fixing holes 650 in the area between the first circumference 630 and the second circumference 640 are different with the shapes of the first auxiliary bristle fixing holes 612 located on the first circumference 630 and the shapes of the second auxiliary bristle fixing holes 622 located on the second circumference 640, so that a density of the bristle fixing holes of the area between the first circumference 630 and the second circumference 640 is relatively high.

Furthermore, second reinforcing bristle fixing holes 660 are defined on one side of the second circumference 640 away from the first circumference 630. The second reinforcing bristle fixing holes 660 are located in the second bristle fixing hole area 620. The second reinforcing bristle fixing holes 660 are defined in the interval between the first auxiliary bristle fixing hole 612 and the second auxiliary bristle fixing hole 622 along the width direction. Therefore, by providing the second reinforcing bristle fixing holes 660, the projection intervals between the first projections of the first auxiliary bristle fixing hole 612 and the first projections of the second auxiliary bristle fixing holes 622 are further filled.

Furthermore, a minimum distance between each two adjacent bristle fixing holes on the bristle fixing surface 600 of the bristle fixing plate 60 is no more than 3 mm and no less than 0.5 mm. If the distance between each two adjacent bristle fixing holes is too large (greater than 3 mm), when the bristles are fixed in the bristle fixing holes, the bristles are sparse, affecting a brushing effect. If the distance between each two adjacent bristle fixing holes is too small (less than 0.5 mm), the bristle fixing surface 600 of the bristle fixing plate 60 easily cracks during the fixing process of the bristles, causing the bristle fixing plate 60 to be scrapped.

In the drawings of the embodiments, the same or similar numbers correspond to the same or similar components. In the description of the present disclosure, it should be understood that terms such as “upper”, “lower”, “left”, “right” etc., indicate direction or position relationships shown based on the drawings, and are only intended to facilitate the description of the present disclosure and the simplification of the description rather than to indicate or imply that the indicated device or element must have a specific direction or constructed and operated in a specific direction. Therefore, the terms used to describe positional relationships in the drawings are only for illustrative purposes and cannot be construed as limitations of the present disclosure. For those of ordinary skill in the art, the specific meanings of the above terms can be understood according to specific circumstances.

The above are only optional embodiments of the present disclosure and are not intended to limit the present disclosure. Any modifications, equivalent substitutions, and improvements made within the spirit and principles of the present disclosure shall be included in the protection scope of the present disclosure.

What is claimed is:

1. A brush head, comprising:
a brush rod,
a brush plate,
bristles, and
a soft elastic piece;
wherein the brush rod defines a length direction; the brush plate comprises a bristle fixing plate and a back plate; at least one of the back plate and the bristle fixing plate is connected to the brush rod; the bristle fixing plate comprises a bristle fixing surface, a back surface, and a peripheral side surface; the back surface of the bristle fixing plate is opposite to the bristle fixing surface of the bristle fixing plate; the peripheral side surface of the bristle fixing plate is located between the bristle fixing surface and the back surface of the bristle fixing plate; the bristles are extended from the bristle fixing surface of the bristle fixing plate; the back plate is connected to one side of the bristle fixing plate away from the bristles; a portion of the back plate is spaced apart from the back surface of the bristle fixing plate to define a filling groove;
the soft elastic piece is filled in the filling groove; the soft elastic piece is covered on the back plate and at least a part of the peripheral side surface of the bristle fixing plate.

2. The brush head according to claim 1, wherein the soft elastic piece comprises a first filling portion; the brush plate defines a width direction and a thickness direction; the width direction, the thickness direction, and the length direction are perpendicular to each other; the filling groove penetrates through the brush plate along the width direction to form two filling openings opposite to each other along the width direction; the filling openings allow injecting liquid to flow into the filling groove during an injection molding process; and the injecting liquid is solidified in the filling groove to form the first filling portion.

3. The brush head according to claim 2, wherein along the thickness direction of the brush plate, a thickness of the soft elastic piece at the filling openings is greater than a thickness of the soft elastic piece at other positions, so as to form outer soft rubber contours on a back portion of the brush head.

4. The brush head according to claim 1, wherein the brush rod comprises a connecting section connected to the brush plate; the soft elastic piece is further covered on the connecting section circumferentially.

5. The brush head according to claim 1, wherein in a width direction of the brush plate, the back plate has a first width, the bristle fixing plate has a second width, and the first width is less than the second width.

6. The brush head according to claim 1, wherein in a thickness direction of the brush plate, the back plate has a first thickness, the bristle fixing plate has a second thickness, and the first thickness is less than the second thickness.

7. The brush head according to claim 1, wherein in a thickness direction of the brush plate, the bristle fixing surface of the bristle fixing plate protrudes from the soft elastic piece, so that the peripheral side surface of the bristle fixing plate is partially exposed to the soft elastic piece.

8. The brush head according to claim 1, wherein the back plate comprises a first connecting end close to the brush rod and a second connecting end away from the brush rod along the length direction;
the back plate is connected to the bristle fixing plate through the first connecting end and the second connecting end thereof, and the filling groove is defined between the first connecting end and the second connecting end of the back plate; or
the back plate is connected to the bristle fixing plate through the first connecting end thereof, the second connecting end of the back plate is suspended, and filling openings are defined between the second connecting end of the back plate and the back surface of the bristle fixing plate; or
the back plate is connected to the bristle fixing plate through the second connecting end thereof, the first connecting end of the back plate is suspended, and the filling openings are defined between the first connecting end of the back plate and the back surface of the bristle fixing plate.

9. The brush head according to claim 8, wherein the brush plate further comprises at least one connecting portion disposed in the filling groove; the at least one connecting portion connects the back surface of the bristle fixing plate to the back plate; when a plurality of connecting portions are provided, the plurality of connecting portions are disposed at intervals along the length direction.

10. The brush head according to claim 1, wherein the bristle fixing plate and the back plate are integrally formed; or
the bristle fixing plate and the brush rod are integrally formed; or
the back plate and the brush rod are integrally formed; or
the bristle fixing plate, the back plate, and the brush rod are integrally formed.

11. The brush head according to claim 1, wherein at least one slot is defined on the peripheral side surface of the bristle fixing plate; two ends of the at least one slot respectively extend to the bristle fixing surface of the bristle fixing plate and the back surface of the bristle fixing plate; the at least one slot is communicated with the filling groove; the soft elastic piece further comprises at least one second filling portion filled in the at least one slot; when slots are provided, the slots are disposed at intervals.

12. The brush head according to claim 11, wherein the at least one slot has slot cross sections perpendicular to a thickness direction of the brush plate; the slot cross sections gradually increase in a direction from the back surface to the bristle fixing surface of the bristle fixing plate.

13. The brush head according to claim 1, wherein the brush plate defines a thickness direction perpendicular to the length direction; the back plate comprises an outer back surface and an outer wall surface; the outer back surface of the back plate is opposite to the bristle fixing surface of the bristle fixing plate along the thickness direction; the outer wall surface of the back plate is disposed between the bristle fixing surface of the bristle fixing plate and the outer back surface of the back plate; the peripheral side surface of the bristle fixing plate and the outer wall surface of the back plate form an outer peripheral surface of the brush plate;
wherein a bonding portion is disposed on the outer peripheral surface of the brush plate; the bonding portion comprises a first step structure and/or a ridge structure; first cross sections of the brush plate are perpendicular to the thickness direction of the brush plate; the first cross sections are unchanged or gradually reduced from the bonding portion to the bristle fixing surface of the bristle fixing plate along the thickness direction; second cross sections of the brush plate are perpendicular to the thickness direction of the brush plate; the second cross sections are unchanged or gradually reduced along the thickness direction from the bonding portion to the back surface of the bristle fixing plate; the bonding portion is covered by the soft elastic piece.

14. The brush head according to claim 13, wherein the brush rod and the brush plate are integrally formed by injection molding; the brush rod comprises a middle cross section perpendicular to the thickness direction; the bonding portion comprises a maximum cross section perpendicular to the thickness direction; the maximum cross section of the bonding portion completely overlaps the middle cross section of the brush rod.

15. The brush head according to claim 13, wherein the brush rod comprises a first rod section and a second rod section; the first rod section is connected to the brush plate through the second rod section; cross sections of the first rod section perpendicular to the length direction are greater than cross sections of the second rod section perpendicular to the length direction, so that a second step structure is defined between the first rod section and the second rod section; the second step structure comprises a second step surface disposed towards the brush plate; a sleeving portion is sleeved on the second rod section and abuts against the second step surface of the second step structure.

16. The brush head according to claim 1, wherein the bristles comprise friction increasing clusters, and a surface roughness of the friction increasing clusters is greater than a surface roughness of other bristles.

17. The brush head according to claim 16, wherein the bristle fixing surface of the bristle fixing plate comprises a first area and a second area; the first area and the second area are located along the length direction; the first area is closer to the brush rod than the second area;
wherein the bristles comprise a first bristle group disposed in the first area and a second bristle group disposed in the second area; the first bristle group comprises the friction increasing clusters.

18. The brush head according to claim 1, wherein the bristle fixing plate defines a width direction perpendicular to the length direction; bristle fixing holes configured to fix the bristles are defined on the bristle fixing surface of the bristle fixing plate; the bristle fixing surface of the bristle fixing plate comprises a first bristle fixing area and a second bristle fixing area; the first bristle fixing area and the second bristle fixing area are disposed along the length direction; the first bristle fixing area defines at least one first central bristle fixing hole and first auxiliary bristle fixing holes; the first auxiliary bristle fixing holes are disposed at intervals around the at least one first central bristle fixing hole; the second bristle fixing area defines second auxiliary bristle fixing holes disposed at intervals; a density of the bristle fixing holes of the first bristle fixing area differs from a density of the bristle fixing holes of the second bristle fixing area;
wherein projections of the bristle fixing holes on the width direction along the length direction are defined as first projections; at least part of projections of the second auxiliary bristle fixing holes are located in projection intervals of adjacent first auxiliary bristle fixing holes, and/or at least part of projections of the first auxiliary bristle fixing holes are located in projection intervals of adjacent second auxiliary bristle fixing holes; so that the first projections of the bristle fixing holes are connected together to form a continuous line segment.

19. A brush head, comprising:
a brush rod,
a brush plate,
bristles, and
a soft elastic piece;
wherein the brush rod defines a length direction; the brush plate comprises a bristle fixing plate and a back plate; at least one of the back plate and the bristle fixing plate is connected to the brush rod; the bristle fixing plate comprises a bristle fixing surface, a back surface, and a peripheral side surface; the back surface of the bristle fixing plate is opposite to the bristle fixing surface of the bristle fixing plate; the peripheral side surface of the bristle fixing plate is located between the bristle fixing surface and the back surface of the bristle fixing plate; the bristles are extended from the bristle fixing surface of the bristle fixing plate; the back plate is disposed on one side of the bristle fixing plate away from the bristles;
wherein the brush plate defines a thickness direction perpendicular to the length direction; the back plate comprises an outer back surface and an outer wall surface; the outer back surface of the back plate is opposite to the bristle fixing surface of the bristle fixing plate along the thickness direction; the outer wall surface of the back plate is disposed between the bristle fixing surface of the bristle fixing plate and the outer wall surface of the back plate; the peripheral side surface of the bristle fixing plate and the outer wall surface of the back plate form an outer peripheral surface of the brush plate; a bonding portion is disposed on the outer peripheral surface of the brush plate; the bonding portion comprises a first step structure and/or a ridge structure;
wherein the soft elastic piece is covered on the back plate and at least a part of the peripheral side surface of the bristle fixing plate; the bonding portion is covered by the soft elastic piece.

20. An electric toothbrush, comprising: a brush head and a brush handle assembly; wherein the brush handle assembly is detachably connected to the brush head, the brush head comprises a brush rod, a brush plate, bristles, and a soft elastic piece;
wherein the brush rod defines a length direction; the brush plate comprises a bristle fixing plate and a back plate; at least one of the back plate and the bristle fixing plate is connected to the brush rod; the bristle fixing plate comprises a bristle fixing surface, a back surface, and a peripheral side surface; the back surface of the bristle fixing plate is opposite to the bristle fixing surface of the bristle fixing plate; the peripheral side surface of the bristle fixing plate is located between the bristle fixing surface and the back surface of the bristle fixing plate; the bristles are extended from the bristle fixing surface of the bristle fixing plate; the back plate is disposed on one side of the bristle fixing plate away from the bristles; a portion of the back plate is spaced apart from the back surface to define a filling groove; the back plate comprises a first connecting end close to the brush rod and a second connecting end away from the brush rod along the length direction; the back plate is connected to the bristle fixing plate through the first connecting end and/or the second connecting end of the back plate;
the soft elastic piece is filled in the filling groove; the soft elastic piece is covered on the back plate and at least a part of the peripheral side surface of the bristle fixing plate.
